(19) United States
(12) Patent Application Publication
(10) Pub. No.: US 2018/0143747 A1
(43) Pub. Date: May 24, 2018

(54) USER INTERFACE DEVICE AND METHOD FOR DISPLAYING SCREEN OF USER INTERFACE DEVICE

(71) Applicant: MITSUBISHI ELECTRIC CORPORATION, Tokyo (JP)

(72) Inventors: Yuki SAKAI, Tokyo (JP); Shogo YONEYAMA, Tokyo (JP); Takeshi SHIMIZU, Tokyo (JP)

(73) Assignee: Mitsubishi Electric Corporation, Tokyo (JP)

(21) Appl. No.: 15/568,094

(22) PCT Filed: May 19, 2015
(86) PCT No.: PCT/JP2015/064246

§ 371 Date: Oct. 20, 2017

(51) Int. Cl. G06F 3/0482; G06F 3/0481; G06T 11/20

(52) U.S. Cl. CPC G06F 3/0482; B60K 2350/1004; G06T 11/20; G06F 3/04817

(57) ABSTRACT

In a user interface (UI) device, an exclusion part extraction unit excludes an indeterminate part or a dynamically changing part as an exclusion part from a to-be-cached part group among a plurality of UI parts that constitute a screen. A cache information generation unit generates drawing information about the to-be-cached part group excluding the exclusion part, and registers the generated drawing information in a drawing information cache unit. When a screen is drawn using the drawing information about the to-be-cached part group excluding the exclusion part, the drawing information being registered in the drawing information cache unit, the exclusion part combining unit combines drawing information that corresponds to the exclusion part with the drawing information about the to-be-cached part group excluding the exclusion part.

### TECHNICAL FIELD

The present invention relates to a user interface device.

### BACKGROUND ART

User interfaces (UIs) that provide means for operating information devices are getting complicated in recent years with the advancements and complications of functions provided by the information devices. On the other hand, consumers are expecting more and more quality of screens displayed on information devices. As a result, the capability of drawing screens has not kept up with the rapid advancements in the hardware performance of information devices.

Some user interface devices (UI devices) for information devices selectively switch and display screen groups, each consisting of a plurality of UI parts such as image parts and text parts. In such UI devices, in order to ensure comfortable responsiveness for users, drawing information about screens that have once undergone drawing processing or that are constructed in advance is cached in a high-speed storage device, and when the same screens are to be displayed thereafter, the cached drawing information is used to speed up the drawing of the screens. For example, Patent Document 1 below discloses a technique for previously caching drawing information about screens that possibly transition to other screens, in order to speed up the drawing of screens at the time of actual screen transition.

In the UI devices that compose each screen of a plurality of UI parts, a model that is generally called a “scene graph” and that is obtained by arranging UI parts of a screen in a hierarchical tree structure is used in order to facilitate design of the screen and management of the UI parts. A technique is also known in which a single UI part (integrated UI part) is created by integrating the contents of drawing of sub-graphs that constitute part of a scene graph so as to simplify the structure of the scene graph, and drawing information about the integrated UI part is cached to further speed up the drawing of screens. For example, Patent Document 2 below discloses a technique in which a list of drawing information such as parameter values held by each UI part is made for a scene graph, and a plurality of pieces of drawing information having different contents are cached as arbitrarily UI parts. Patent Document 2 further attempts to increase the drawing speed by holding a bitmap (image) that represents the content of an arbitrary sub-graph, as one of the parameter values.

### PRIOR ART DOCUMENTS

### Patent Documents

Patent Document 1: Japanese Patent Application Laid-Open No. 2002-175142

Patent Document 2: Japanese Patent Application Laid-Open No. 2003-162733

### SUMMARY

### Problems to be Solved by the Invention

In UI devices that cache drawing information about a plurality of UI parts, the structure of a scene graph will become more simplified and the effect of increasing the drawing speed will increase with an increase in the size of a sub-graph to be cached from the scene graph. However, there is a problem in that the cached drawing information may not be used as it is if the UI parts of the sub-graph include any UI part (indeterminate part) whose drawing content cannot be determined or any UI part (dynamically changing part) whose drawing content changes dynamically. For example, a UI part for the image of a clock that displays the current time is an indeterminate part because its drawing content is determined only at the time of actual screen transition, and this UI part is also a dynamically changing part because its drawing content changes dynamically.

The technique as disclosed in Patent Document 1 for constructing drawing information about a transition destination screen in advance is not applicable to the case where any indeterminate part exists, because drawing information about indeterminate parts cannot be constructed in advance. The technique as disclosed in Patent Document 2 for constructing an integrated UI part corresponding to a sub-graph has a problem if the integrated UI part includes any dynamically changing part, because the integrated UI part can no longer be used if any change is made to the contents of some UI parts of the integrated UI part. For example, the need to regenerate an integrated UI part will arise every time a change is made to dynamically changing parts included in the integrated UI part. This hinders an increase in the speed of drawing screens.

As a countermeasure, a method is conceivable in which a plurality of different types of drawing information are constructed and cached in advance, or a plurality of different integrated UI parts are generated and cached, in order to cope with every possible pattern of changes to be made to indeterminate parts and dynamically changing parts. This method, however, undesirably increases storage capacity required for caching.

As another countermeasure, there is also a method in which a sub-graph (integrated UI part) to be cached is further divided into a plurality of smaller sub-graphs in order to prevent the sub-graph from including any indeterminate part or any dynamically changing part. This method, however, lessens the effect of simplifying the structure of a scene graph. In addition, if the plurality of sub-graphs in the integrated UI part have overlaps of drawing regions, the storage capacity required for caching will increase by the amount corresponding to the area of overlap.

A solution is also conceivable in which the entire structure of a scene graph is changed to prevent the integrated UI part from including any indeterminate part or any dynamically changing part. However, the scene graph created in defiance of the semantic structure of the screen compromises the advantage of the scene graph, i.e., the advantage to facilitating design of the screen and management of the UI parts.

The present invention has been achieved to solve the problems as described above, and it is an object of the present invention to provide a user interface device that is capable of efficiently caching drawing information about each screen without changing the structure of a scene graph, even if sub-graphs include an indeterminate part or a dynamically changing part.

### Means to Solve the Problems

The user interface device according to the present invention includes an exclusion part extraction unit (105) that excludes an indeterminate part or a dynamically changing part as an exclusion part from a to-be-cached part group among a plurality of UI parts that constitute a screen of a user interface (UI), a cache information generation unit (106) that generates drawing information about the to-be-cached part group excluding the exclusion part, a drawing information cache unit (107) in which drawing information about the to-be-cached part group excluding the exclusion part is registered, and an exclusion part combining unit (108) that, in a case where a screen is drawn using drawing information about the to-be-cached part group excluding the exclusion part, the drawing information being registered in the drawing information cache unit (107), combines drawing information that corresponds to the exclusion part with the drawing information about the to-be-cached part group excluding the exclusion part.

### Effect of the Invention

According to the present invention, even if a sub-graph includes an indeterminate part or a dynamically changing part, a cache can be used effectively without requiring any change to the structure of a scene graph. This contributes to speeding up the drawing of screens of the user interface device. In UI development, the present invention also achieves the effect of reducing the number of man-hours needed to design a UI screen in consideration of drawing performance and the number of man-hours relating to performance tuning.

These and other objects, features, aspects and advantages of the, present invention will become more apparent from the following detailed description of the present invention when taken in conjunction with the accompanying drawings.

### BRIEF DESCRIPTION OF DRAWINGS

FIG. 1 is a functional block diagram illustrating a configuration of a UI device according to Embodiment 1.

FIG. 2 is a block diagram illustrating an exemplary hardware configuration of the UI device according to the present invention.

FIG. 3 illustrates an exemplary screen displayed on the UI device according to the present invention.

FIG. 4 illustrates individual UI parts that constitute the screen in FIG. 3.

FIG. 5 illustrates an exemplary screen model that corresponds to the screen in FIG. 3.

FIG. 6 is a diagram for describing processing for excluding an exclusion part from a to-be-cached part group and processing for combining an exclusion part with a UI part group that is read from a cache.

FIG. 7 is a flowchart of operations performed by a screen model construction unit in the UI device according to Embodiment 1.

FIG. 8 is a flowchart of operations, performed by an exclusion part extraction unit in the UI device according to Embodiment 1.

FIG. 9 is a flowchart of operations performed by a cache information generation unit in the UI device according to Embodiment 1.

FIG. 10 is a flowchart of operations performed by a drawing information cache unit in the UI device according to Embodiment 1.

FIG. 11 is a flowchart of operations performed by an exclusion part combining unit in the UI device according to Embodiment 1.

FIG. 12 is a functional block diagram illustrating a configuration of a UI device according to Embodiment 2.

FIG. 13 illustrates an exemplary screen model that uses an integrated UI part according to Embodiment 2.

FIG. 14 is a flowchart of operations performed by an integrated-UI-part generation unit in the UI device according to Embodiment 2.

FIG. 15 is a flowchart of operations performed by a screen model construction unit in the UI device according to Embodiment 2.

FIG. 16 is a functional block diagram illustrating a configuration of a UI device according to Embodiment 3.

FIG. 17 is a flowchart of operations performed by a mask-region generation unit in the UI device according to Embodiment 3.

FIG. 18 is a flowchart of operations performed, by a mask processing unit in the UI device according to Embodiment 3.

FIG. 19 is a flowchart of operations performed by a cache information generation unit in the UI device according to Embodiment 3.

FIG. 20 is a functional block diagram illustrating a configuration of a UI device according to Embodiment 4.

FIG. 21 is a flowchart of operations performed by a screen-model prior generation unit in the UI device according to Embodiment 4.

FIG. 22 is a flowchart of operations performed by a screen model construction unit in the UI device according to Embodiment 4.

FIG. 23 is a functional block diagram illustrating a configuration of a UT device, according to Embodiment 5.

FIG. 24 is a flowchart of operations performed by an exclusion part determination unit in the UI device according to Embodiment 5.

FIG. 25 is a functional block diagram illustrating a configuration of a UI device according to Embodiment 6.

FIG. 26 is a flowchart of operations performed by a drawing tendency estimation unit in the UI device according to Embodiment 6.

FIG. 27 is a flowchart of operations performed by a drawing tendency holding unit in the UI device according to Embodiment 6.

FIG. 28 is a flowchart of operations performed by a to-be-cached-part determination unit in the UI device according to Embodiment 6.

FIG. 29 is a functional block diagram illustrating a configuration of a UI device according to Embodiment 7.

FIG. 30 is a flowchart of operations performed by an execution-by-proxy determination unit in the UI device according to Embodiment 7.

FIG. 31 is a flowchart of operations performed by an execution-by-proxy entrustment unit in the UI device according to Embodiment 7.

FIG. 32 is a functional block diagram illustrating a configuration of a UI device according to Embodiment 8.

FIG. 33 is a flowchart of operations performed by a dependency relation extraction unit in the UI device according to Embodiment 8.

### DESCRIPTION OF EMBODIMENTS

Embodiments of the present invention will now be described hereinafter with reference to the attached drawings in order to describe the present invention in more detail.

### Embodiment 1

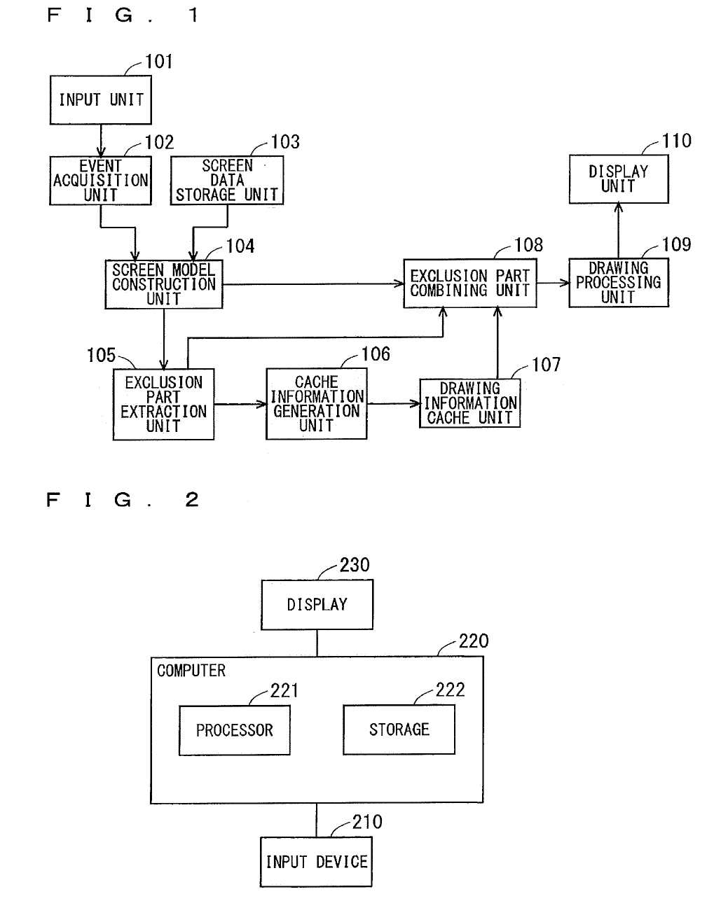

FIG. 1 is a block diagram of a user interface device (UI device) according to Embodiment 1 of the present invention. As illustrated in FIG. 1, the UI device includes an input unit 101, an event acquisition unit 102, a screen data storage unit 103, a screen model construction unit 104, an exclusion part extraction unit 105, a cache information generation unit 106, a drawing information cache unit 107, an exclusion part combining unit 108, a drawing processing unit 109, and a display unit 110.

The input unit 101 is a device that is used by a user to operate a UI screen displayed on the display unit 110. Specific examples of the input unit 101 include pointing devices such as mice, touch panels, trackballs, data gloves, and styluses; keyboards; voice input devices such as microphones; image and video input devices such as cameras; input devices using brain waves; and sensors and the like such as motion sensors.

The input unit 101 presents various types of operations in the form of user input events and transmits such events to the event acquisition unit 102. When the input unit 101 is a mouse, examples of the user input events include moving a cursor with the mouse, starting or stopping clicking of the right or left button, double-clicking, dragging, mouse wheeling, moving the cursor toward a specific display element, putting the cursor on a specific display element, and moving the cursor away from a specific display element. When the input unit 101 is a touch panel, examples of the user input events include gesture operations using a single or a plurality of fingers, such as tapping, double-tapping, holding, flicking, swiping, pinching-in, pinching-out, and rotating; and moving an indicator (user's finger) toward a touch panel screen. When the input unit 101 is a keyboard, examples of the user input events include pressing a key, releasing a key, and operating a plurality of keys at the same time. Alternatively, original or new user input events may be defined on the basis of, for example, time, speed, acceleration, and a combination of a plurality of users, or a combination of a plurality of input devices. In addition to the examples given here, any operation intended or wished by users may be handled as a user input event.

The event acquisition unit 102 acquires an event that triggers a change to the content of the screen displayed on the display unit 110, and transmits this event to the screen model construction unit 104. Examples of the event include, in addition to the user input events transmitted from the input unit 101, system events transmitted from the hardware or operating system, and timer events generated at regular intervals. In addition, internal events that are internally generated by a screen model itself may be prepared in order to cause successive updating of a screen such as animation.

The screen data storage unit 103 stores image data that is necessary to determine the content of a screen to be displayed on the display unit 110. Examples of the image data include screen layouts, screen transition charts, screen control programs, UI part parameter values, animation information, databases, images, fonts, videos, and voices. In addition to the examples given here, any type of data may be stored as image data in the screen data storage unit 103.

The screen model construction unit 104 reads image data from the screen data storage unit 103 and constructs a screen model. The screen model is assumed to be a model that represents the content of the screen displayed on the display unit 110 and have a hierarchical structure of one or more layers, each consisting of a plurality of UI parts (hereinafter, also simply referred to as “parts”). For example, the aforementioned scene graph is one example of the screen model having a hierarchical structure.

The UI parts are constituent elements of a screen and may be text parts that draw character strings, or image parts that paste images on the screen. Other examples of the UI parts include parts that paste videos on the screen, parts that draw ellipses, parts that draw rectangles, parts that draw polygons, and panel parts. In addition, logics that control screens, such as animation parts and screen transition charts, may also be handled as UI parts.

Each UI part holds UI part parameter values according to the type. Examples of the UI part parameter values that are held by every UI part, irrespective of the type of the UI part, include a part ID, coordinates, a width, and a height. Examples of the UI part parameter values that are held by only specific types of UI parts include UI part parameter values held by text parts such as character strings, fonts, and colors, and UI part parameter values held by image parts such as image file paths, scales, and rotational angles. In Embodiment 1, it is assumed that every UI part holds at least a UI part parameter value that indicates whether the UI part is to be cached, and a UI part parameter value that indicates whether the UI part is an exclusion part. The structure of the screen model and the UI part parameters for each UI part included in the screen model are determined when the screen model construction unit 104 constructs the screen model.

The screen model construction unit 104 also updates a screen model by, for example, executing a screen transition chart or a screen control program on the basis of the event acquired by the event acquisition unit 102 (event that triggers a change to the content of the screen displayed on the display unit 110). The screen model construction unit 104 then transmits the content of the updated screen model to the exclusion part combining unit 108. The screen model construction unit 104 further transmits a group of parts to be cached (to-be-cached part group), included in the updated screen model, to the exclusion part extraction unit 105 on the basis of the UI part parameter values held by each UI part and indicating whether the UI part is to be cached.

The exclusion part extraction unit 105 performs processing for separating exclusion parts, on the to-be-cached part group received from the screen model construction unit 104, on the basis of the UI part parameter values that indicate whether each UI part is an exclusion part. The exclusion part extraction unit 105 further transmits the separated exclusion parts to the exclusion part combining unit 108 and transmits the to-be-cached part group excluding the exclusion parts (also referred to as the “to-be-cached part group after removal of exclusion parts”) to the cache information generation unit 106.

The processing for excluding exclusion parts does not need to be performed on a to-be-cached part group that includes no exclusion parts from the beginning. Thus, the exclusion part extraction unit 105 transmits a to-be-cached part group that includes no exclusion parts as it is to the exclusion part extraction unit 105. In the specification of the present invention, although the to-be-cached part groups that are output from the exclusion part extraction unit 105 are referred to as “to-be-cached part groups excluding exclusion parts” or “to-be-cached part groups after removal of exclusion parts” for the convenience of description, the to-be-cached part groups also include to-be-cached part groups that include no exclusion parts from the beginning.

The cache information generation unit 106 generates drawing information (cache information) that is to be cached in the drawing information cache unit 107, from the to-be-cached part group after removal of exclusion parts, which is received from the exclusion part extraction unit 105. The drawing information is information that is necessary to determine a screen to be displayed on the display unit 110. Specific examples of the drawing information include the whole or part of the screen model, parameters held by the screen model, and textures such as objects and images. In addition to the examples given here, graphics commands, frame buffer objects, and the like may also be handled as the drawing information. The drawing information generated by the cache information generation unit 106 is transmitted to the drawing information cache unit 107.

The drawing information cache unit 107 registers (caches) the drawing information received from the cache information generation unit 106. The drawing information cache unit 107 also performs processing for reading the cached drawing information about the to-be-cached part group and transmitting this drawing information to the exclusion part combining unit 108.

The exclusion part combining unit 108 generates drawing information on the basis of the content of the screen model received from the screen model construction unit 104 and the content of the exclusion part received from the exclusion part extraction unit 105 and combines the generated drawing information with the drawing information received from the drawing information cache unit 107 to generate complete drawing information about a screen to be displayed on the display unit 110. The exclusion part combining unit 108 transmits this complete drawing information to the drawing processing unit 109.

The drawing processing unit 109 generates drawing data that can be displayed on the display unit 110, from the drawing information received from the exclusion part combining unit 108. The drawing data is generated by, for example, using a graphics application programming interface such as OpenGL or Direct3D and causing graphics hardware to execute rendering processing in accordance with the content of the drawing information. The drawing processing unit 109 transmits the generated drawing data to the display unit 110.

The display unit 110 is a device that displays a screen based on the drawing data generated by the drawing processing unit 109, and may be a liquid crystal display or a touch panel.

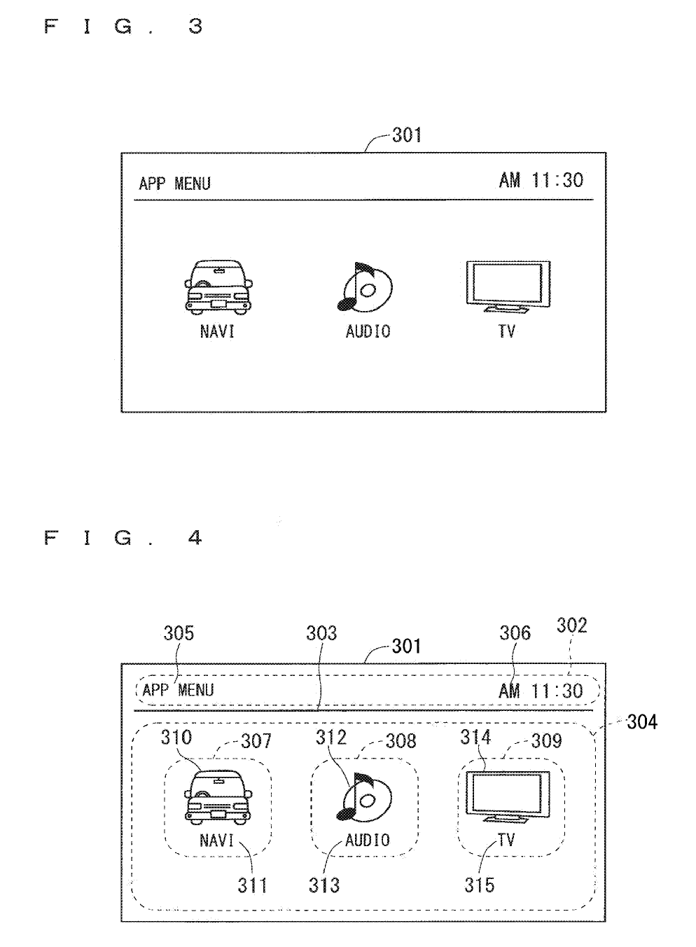

FIG. 2 illustrates an exemplary hardware configuration that implements, the UI device according to the present invention. As illustrated in FIG. 2, the hardware configuration of the UI device includes an input device 210, a computer 220, and a display 230.

The input device 210 may be a mouse, a keyboard, or a touch pad and implements the functions of the input unit 101. The display 230 may be a liquid crystal display and implements the functions of the display unit 110.

The computer 220 includes a processor 221 such as a central processing unit (CPU) (which is also referred to as a central processing unit, processing unit, an arithmetic unit, a microprocessor, a microcomputer, a processor, or a DSP) and a storage 222 such as a memory. Examples of the memory include nonvolatile or volatile semiconductor memories such as RAMs, ROMs, flash memories, EPROMs, and EEPROMs, and disks such as magnetic disks, flexible disks, optical disks, compact disks, minidisks, and DVDs. The functions of the event acquisition unit 102, the screen model construction unit 104, the exclusion part extraction unit 105, the cache information generation unit 106, the exclusion part combining unit 108, and the drawing processing unit 109 of the UI device are implemented by the processor 221 executing programs stored in the storage 222.

The processor 221 may include a plurality of cores that execute processing based on programs. The input device 210 and the display 230 may be configured as a single device (e.g., touch panel device) that functions as both of the input unit 101 and the display unit 110. As another alternative, the input device 210, the display 230, and the computer 220 may be configured as a single integrated device (e.g., a smartphone or a tablet terminal).

FIG. 3 illustrates an exemplary screen displayed on the UI device according to the present invention, and illustrates a screen 301 (application menu screen) that shows a selection menu in an application (hereinafter, simply referred to as “app”).

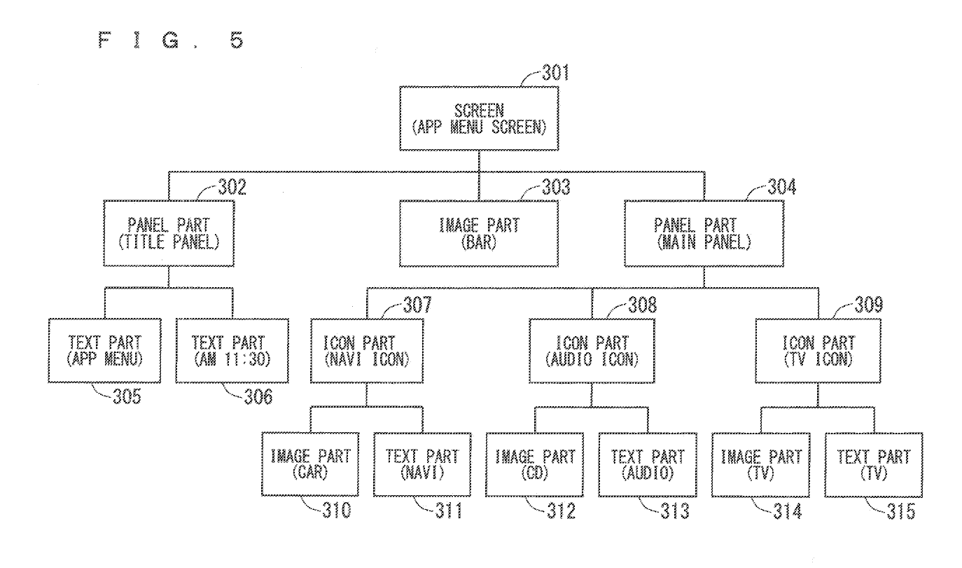

The screen 301 is configured by a hierarchical combination of a plurality of UI parts 302 to 315 illustrated in FIG. 4. That is, the screen 30, which serves as an app menu screen, is configured by a panel part 302 that draws an image of a title panel, an image part 303 that draws an image of a horizontal line (bar), and a panel part 304 that draws an image of a main panel, the panel parts 302 and 304 being further configured by a combination of lower-level UI parts (the image part 303 is configured by only a single UI part).

The panel part 302 is configured by the text part 305 that draws a character string saying “App Menu,” and the text part 306 that draws a character string representing the current time. The panel part 304 is configured by the icon part 307 that draws an icon (NAVI icon) for selecting a navigation (hereinafter, simply referred to as “NAVI”) app, the icon part 308 that draws an icon (audio icon) for selecting an audio app, and the icon part 309 that draws an icon (TV icon) for selecting a TV app.

The icon part 307 is further configured by the image part 310 that draws an image of an automobile, and the text part 311 that draws a character string saying “NAVI.” The icon part 308 is further configured by the image part 312 that draws images of an optical disk and a musical note, and the text part 313 that draws a character string saying “AUDIO.” The icon part 309 is further configured by the text part 315 that draws an image of a TV, and the text part 315 that draws a character string saying “TV.”

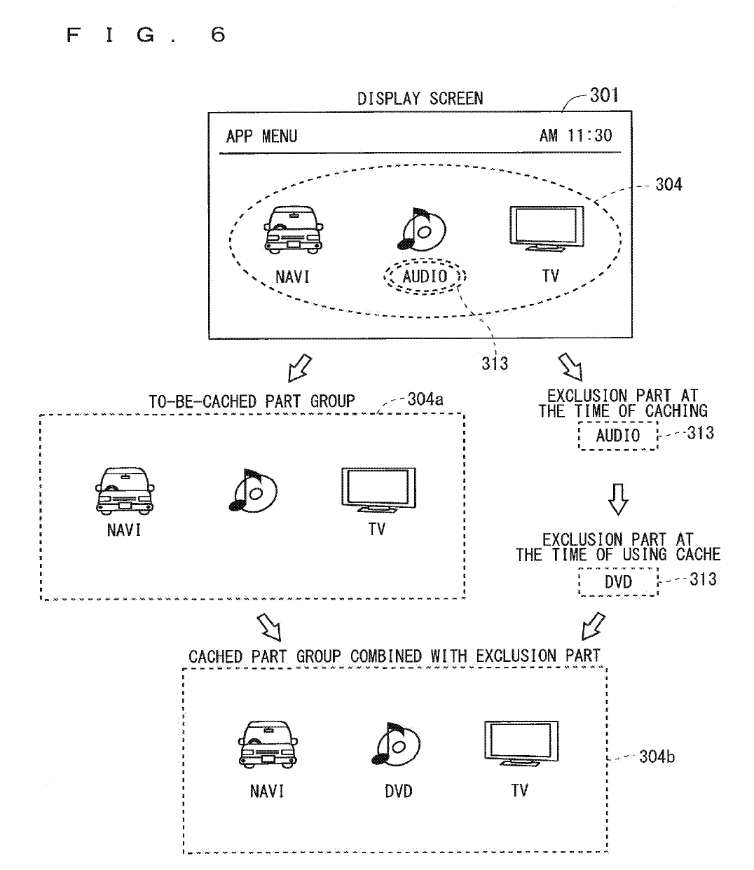

FIG. 5 illustrates an exemplary screen model that corresponds to the screen 301. This screen model is a scene graph that represents a hierarchical relation of the UI parts 302 to 315 that constitute the screen 301 in the form of a tree structure. Note that the entire screen 301 may be regarded as a single UI part and used to draw another screen. While the screen model in FIG. 5 is a scene graph having a tree structure, the scene graph may include a closed circuit if a traverse is possible without causing any exhaustive contradiction.

FIG. 6 illustrates an example of the processing for excluding an exclusion part from a to-be-cached part group and caching the to-be-cached part group in the drawing information cache unit 107, and the processing for combining a UI part group (cached part group) cached in the drawing information cache unit 107 with an exclusion part.

For example, it is assumed that the panel part 304 in the screen 301 is a to-be-cached part group, and the text part 313 included in the, panel part 304 and saving “AUDIO” is a dynamically changing part. In this case, the text part 313 is regarded as an exclusion part. The exclusion part extraction unit 105 separates the panel part 304 into the text part 313, which is an exclusion part, and a panel part 304a that is obtained by excluding the exclusion part (image part 314) from the panel part 304 as illustrated in FIG. 6. The cache information generation unit 106 also generates drawing information about the panel part 304a excluding the exclusion part, and caches the generated drawing information in the drawing information cache unit 107.

A case is assumed in which when the screen 301 is displayed on the display unit 110 by using the panel part 304a (cached part group) cached in the drawing information cache unit 107 thereafter, the content of the text part 313, which is an exclusion part, is to be changed into a character string saying “DVD.” In this case, the exclusion part combining unit 108 reads the panel part 304a from the drawing information cache unit 107 and combines this panel part 304a with the text part 313 saying “DVD” to generate a panel part 304b that includes the character string saying “DVD.” The drawing processing unit 109 uses drawing information about the panel part 304b generated by the exclusion part combining unit 108 to generate drawing data for the screen 301 to be displayed on the display unit 110.

While FIG. 6 illustrates an example in which only the panel part 304 is a to-be-cached part group and only the text part 313 in the to-be-cached part group is an exclusion part, a plurality of to-be-cached part groups may be included in a single screen, or a plurality of exclusion parts may be included in a single to-be-cached part group.

The UI device according to Embodiment 1 performs processing for updating a screen model and processing for drawing a screen based on the screen model when the event acquisition unit 102 has acquired an event such as a user input event that triggers a change to the content of the screen displayed on the display unit 110. The procedure of such processing will now be described hereinafter.

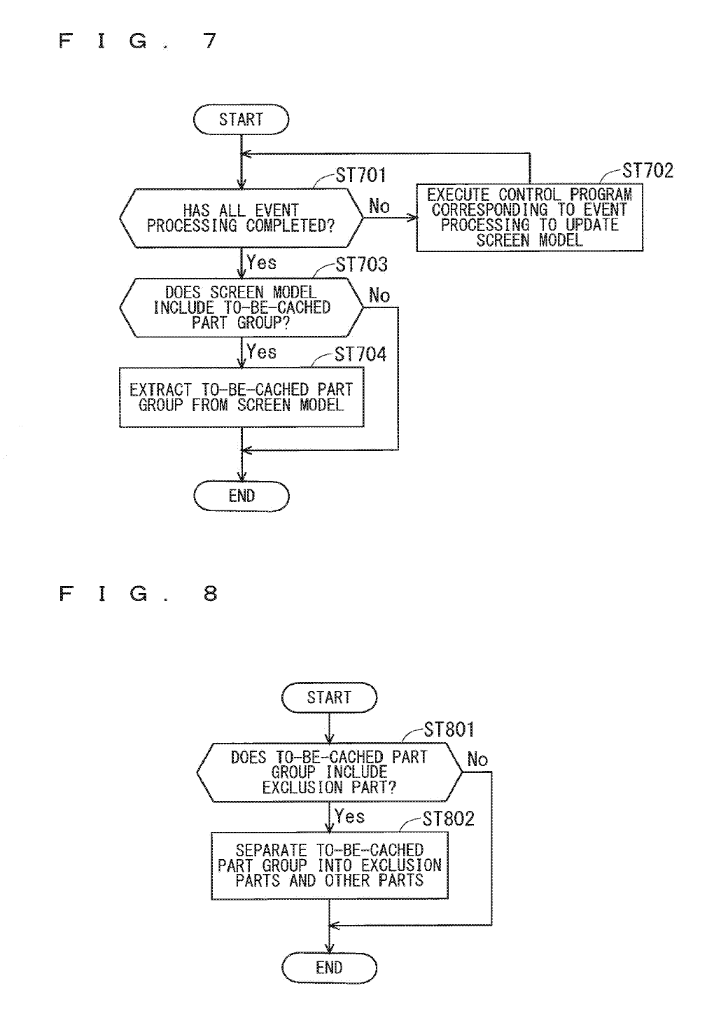

When the event acquisition unit 102 has acquired an event that triggers a change to the content of the screen displayed on the display unit 110, the screen model construction unit 104 performs processing for updating the content represented by the screen model and extracting to-be-cached part groups from the updated screen model. The procedure of this processing will be described hereinafter with reference to the flowchart in FIG. 7.

First, the screen model construction unit 104 checks for the presence of any event to be processed (step ST701). If any event remains to be processed, the screen model construction unit 104 processes each event until the processing is completed for all events. At this time, the screen model construction unit 104 updates the structure and parameter values of the screen model by executing a control program corresponding to the processing performed for each event (step ST702). The screen model construction unit 104 also acquires data as necessary from the screen data storage unit 103.

When the processing is completed for all events, the event acquisition unit 102 confirms whether the updated screen model includes any UI part to be cached (to-be-cached part group) (step ST703). If the updated screen model includes any to-be-cached part group, the event acquisition unit 102 extracts every to-be-cached part group from the screen model (step ST704). If the updated screen model includes no to-be-cached part groups, the event acquisition unit 102 ends the processing without carrying out step ST704.

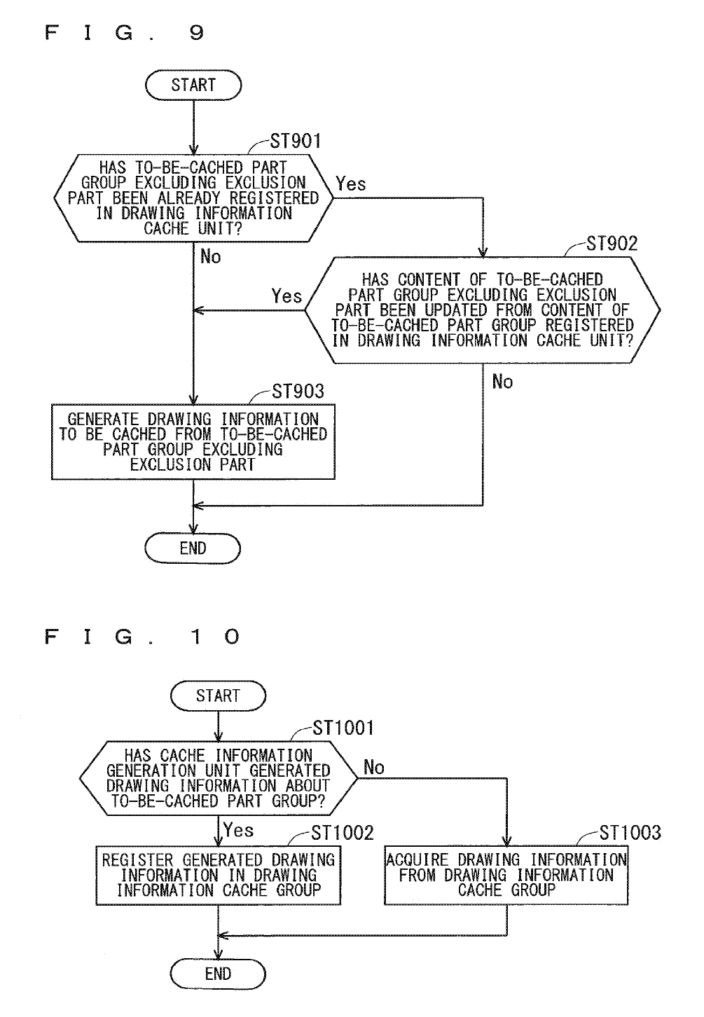

The exclusion part extraction unit 105 performs processing for separating exclusion parts from the to-be-cached part group extracted by the screen model construction unit 104. The procedure of this processing will be described hereinafter with reference to the flowchart in FIG. 8.

First, the screen model construction unit 104 checks for the presence of any exclusion part included in the to-be-cached part group (step ST801). If the to-be-cached part group includes any exclusion part, the screen model construction unit 104 separates the to-be-cached part group into exclusion parts and to-be-cached part groups excluding the exclusion parts (step ST802). If the to-be-cached part group includes no exclusion parts, the screen model construction unit 104 ends the processing without carrying out step ST802.

The cache information generation unit 106 generates drawing information to be cached in the drawing information cache unit 107 from the to-be-cached part group from which the exclusion parts are excluded by the exclusion part extraction unit 105 (i.e., to-be-cached part group after removal of exclusion parts). The procedure of this processing will be described hereinafter with reference to the flowchart in FIG. 9.

Upon receiving the to-be-cached part group after removal of exclusion parts, the cache information generation unit 106 confirms whether this to-be-cached part group has already been registered (cached) in the drawing information cache unit 107 (step ST901). If the to-be-cached part group is not registered in the drawing information cache unit 107, the cache information generation unit 106 generates drawing information about the to-be-cached part group (step ST903). If the to-be-cached part group has already been registered in the drawing information cache unit 107, the cache information generation unit 106 confirms whether the content of the received to-be-cached part group has been updated (changed) from the content of the to-be-cached part group registered in the drawing information cache unit 107 (i.e., registered to-be-cached part group) by comparing the content of the received to-be-cached part group and the content of the registered to-be-cached part group (step ST902), and carries out step ST903 if the content of the received to-be-cached part group has been updated (step ST903). If the content of the received to-be-cached part group has not been updated, the cache information generation unit 106 ends the processing without carrying out step ST903.

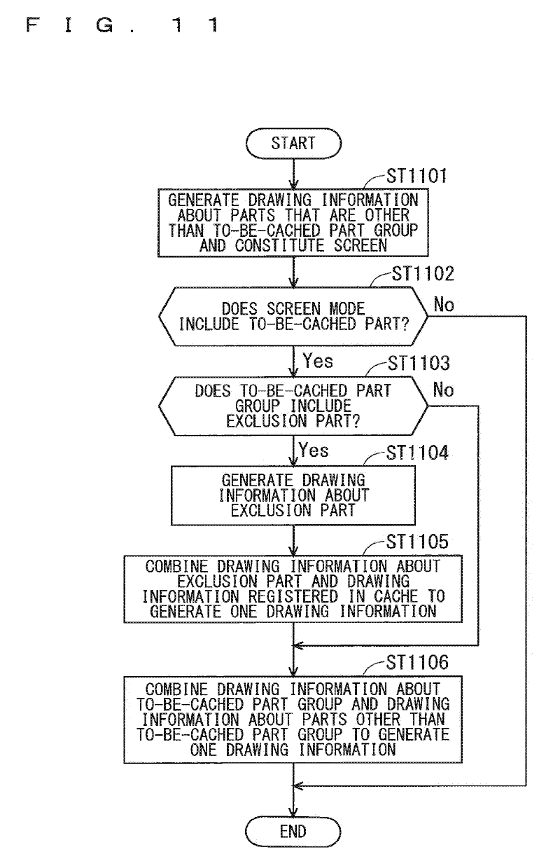

The drawing information cache unit 107 registers (caches) the drawing information generated by the cache information generation unit 106 or reads and acquires the cached drawing information about the to-be-cached part group. The procedure of this processing will be described hereinafter with reference to the flowchart in FIG. 10.

The drawing information cache unit 107 confirms whether the cache information generation unit 106 has generated drawing information about the to-be-cached part group after removal of exclusion parts (step ST1001). If the drawing information about the to-be-cached part group after removal of exclusion parts has been generated (i.e., the drawing information about the to-be-cached part group has not been registered in the drawing information cache unit 107), the drawing information cache unit 107 caches the generated drawing information in the drawing information cache unit 107 (step ST1002). If the drawing information about the to-be-cached part group after removal of exclusion parts has not been generated (i.e., the drawing information about the to-be-cached part group has already been registered in the drawing information cache unit 107), the drawing information cache unit 107 acquires the drawing information about the to-be-cached part group registered in the drawing information cache unit 107 (step ST1003).

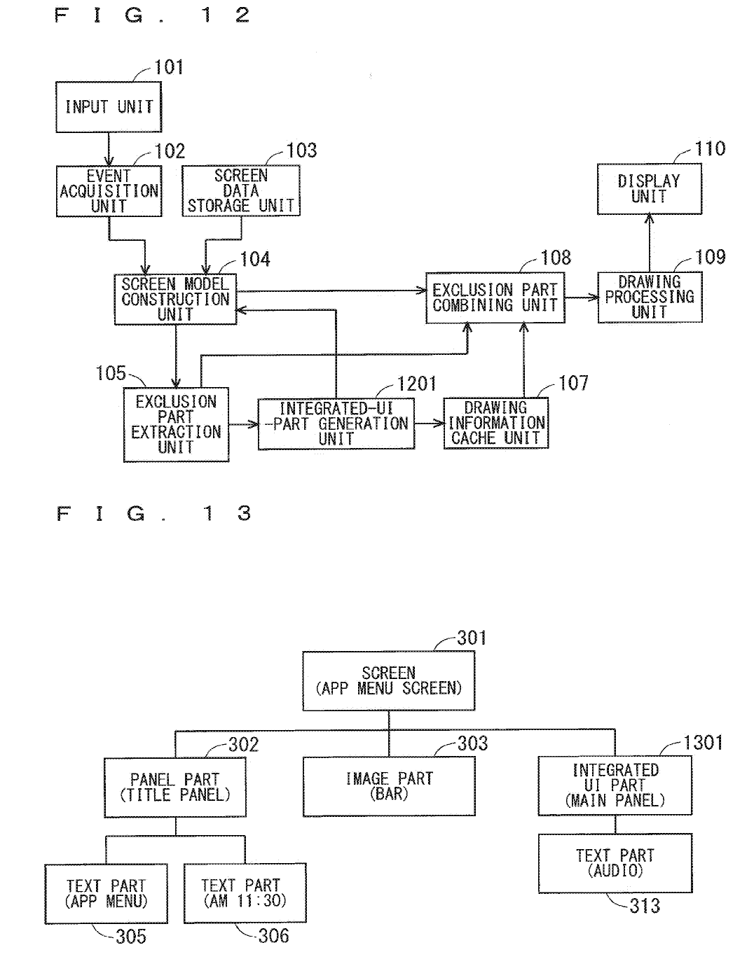

The exclusion part combining unit 108 performs processing for combining the drawing information about the to-be-cached part group and the drawing information about the exclusion part to generate complete drawing information about a screen to be displayed on the display unit 110. The procedure of this processing will be described hereinafter with reference to the flowchart in FIG. 11.

First, the exclusion part combining unit 108 generates drawing information from the UI part group other than the to-be-cached part group, among the UI part groups that constitute the updated screen model (step ST1101). Next, the exclusion part combining unit 108 confirms whether the screen model includes any to-be-cached part group (step ST1102). If the screen model includes no to-be-cached part groups, the exclusion part combining unit 108 ends the processing because the drawing information generated in step ST1101 is complete drawing information about the screen.

On the other hand, if the screen model includes any to-be-cached part group, the exclusion part combining unit 108 confirms whether the to-be-cached part group includes any exclusion part (step ST1103). If the to-be-cached part group includes no exclusion parts, the exclusion part combining unit 108 combines the cached drawing information about the UI part group and the drawing information generated in step ST1101 to generate a single piece of drawing information (complete drawing information about a screen) (step ST1106), and ends the processing. If the to-be-cached part group includes any exclusion part, the exclusion part combining unit 108 generates drawing information about the exclusion part (step ST1104), combines the generated drawing information about the exclusion part with the cached drawing information about the UI part group to generate a single piece of drawing information (step ST1105), further combines the drawing information generated in step ST1105 with the drawing information generated in step ST1101 to generate a single piece of drawing information (complete drawing information about the screen) (step ST1106), and ends the processing.

When the exclusion part combining unit 108 has generated the complete drawing information about the screen, the drawing processing unit 109 generates drawing data from this drawing information and transmits the generated drawing data to the display unit 110. As a result, the screen to be displayed on the display unit 110 is updated.

In this way, with the UI device according to Embodiment 1, when a to-be-cached part group includes any indeterminate part or any dynamically changing part, the exclusion part extraction unit 105 excludes the indeterminate part or the dynamically changing part as an exclusion part from the to-be-cached part group, and the drawing information cache unit 107 caches drawing information about the to-be-cached part group excluding the exclusion part. Then, when this to-be-cached part group is used to display a screen, a current content of the exclusion part is combined with the to-be-cached part group. This allows efficient use of a cache even for a to-be-cached part group that includes any indeterminate part or any dynamically changing part. As a result, it is possible to increase the utilization ratio of a cache and improve the drawing performance of the UI device.

### Embodiment 2

While the UI device according to Embodiment 1 performs the processing (FIG. 9) for generating drawing information from the to-be-cached part group excluding the exclusion part, Embodiment 2 describes a UI device that is configured to perform, instead of the above processing, processing for replacing the to-be-cached part group of the screen model held by the screen model construction unit 104 with an integrated UI part.

FIG. 12 is a block diagram of the UI device according to Embodiment 2. The configuration of this UI device differs from the configuration in FIG. 1 in that an integrated-UI-part generation unit 1201 is provided, instead of the cache information generation unit 106.

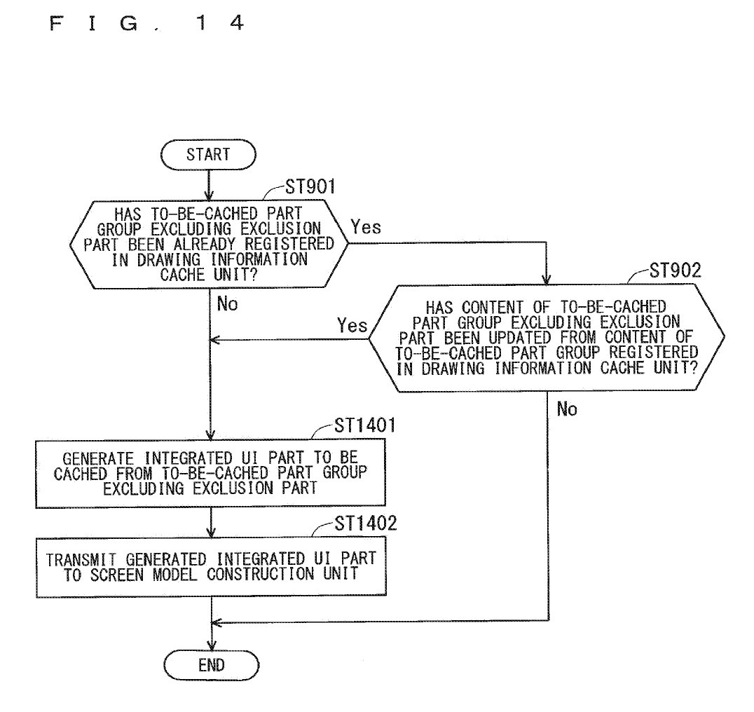

FIG. 13 illustrates an exemplary, screen model that is obtained by replacing the to-be-cached part group with an integrated UI part. In FIG. 13, it is assumed that the panel part 304 is a to-be-cached part group and the text part 313 is an exclusion part as in the example in FIG. 6, but the panel part 304 and the lower-level UI parts 307 to 315 are replaced with a single integrated UI part 1301, unlike in the screen model in FIG. 5. The text part 313, which is an exclusion part, is however not included in the integrated UI part 1301 and remains as a lower-level UI part of the integrated UI part 1301. In this case, the exclusion part combining unit 108 can generate drawing information about the panel part 304 by combining the integrated UI part 1301 with the text part 313, which is an exclusion part.

The integrated-UI-part generation unit 1201 generates drawing information that is to be registered (cached) in the drawing information cache unit 107 from the to-be-cached part group from which the exclusion part is excluded by the exclusion part extraction unit 105, and also generates an integrated UI part that is image data corresponding to the generated drawing information. That is, the integrated UI part handles the drawing content of the to-be-cached part group collectively as a single image part.

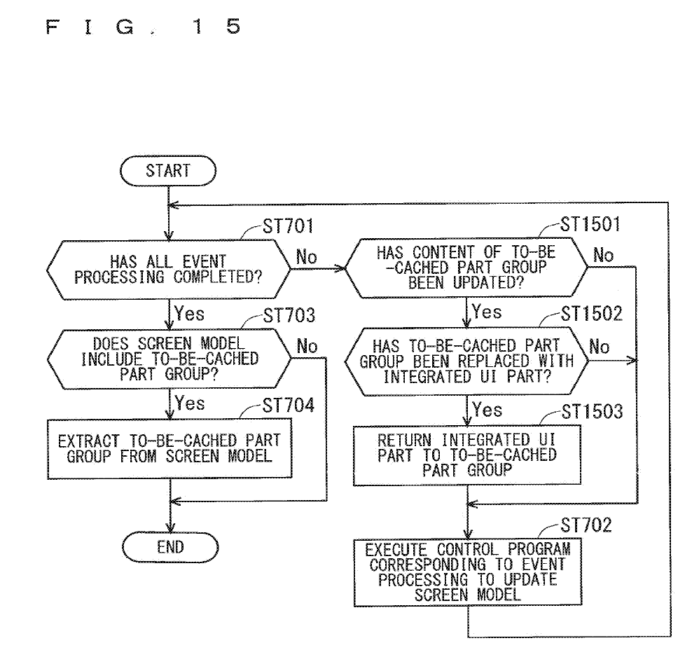

The procedure of this processing will be described hereinafter with reference to the flowchart in FIG. 14. This flowchart is obtained by replacing step ST903 in FIG. 9 with steps ST1401 and ST1402 described below.

In step ST1401, the integrated-UI-part generation unit 1201 generates an integrated UI part from the to-be-cached part group after removal of exclusion parts, the integrated UI part being to be registered (cached) in the drawing information cache unit 107. In step ST1402, the integrated-UI-part generation unit 1201 transmits the integrated UI part generated in step ST1401 to the screen model construction unit 104.

Upon receiving the integrated UI part generated by the integrated-UI-part generation unit 1201, the screen model construction unit 104 performs processing for replacing the to-be-cached part group in the screen model with the integrated UI part. The screen model in which the to-be-cached part group is replaced with the integrated UI part is held as a screen model with a simplified structure in the screen model construction unit 104 until the content of this to-be-cached part group is updated by any event processing for updating the screen.

In the present embodiment, when the content of the to-be-cached part group replaced with the integrated UI part is updated by any event processing for updating the screen, the screen model construction unit 104 performs processing for returning the integrated UI part to a plurality of original UI parts. The procedure of this processing will be described hereinafter with reference to the flowchart in FIG. 15. This flowchart is obtained by adding steps ST1501 and ST1502 described below before step ST702 in FIG. 7.

First, the screen model construction unit 104 checks for the presence of any other event to be processed (step ST701). If any event remains to be processed, the screen model construction unit 104 confirms whether the content of the to-be-cached part group is to be updated by any event processing (step ST1501). If the content of to-be-cached part group is not to be updated, the procedure proceeds to step ST702 in which the screen model construction unit 104 executes a control program corresponding to event processing and updates the screen model.

If the content of the to-be-cached part group is to be updated by any event processing, the screen model construction unit 104 confirms whether this to-be-cached part group has been replaced with an integrated UI part (step ST1502). At this time, if the to-be-cached part group is not replaced with an integrated UI part, the procedure proceeds directly to step ST702. However, if the to-be-cached part group is not replaced with the integrated UI part, the screen model construction unit 104 returns the integrated UI part to the original to-be-cached part group (step ST1503) to enable updating of the content of the to-be-cached part group, and then the procedure proceeds to step ST702.

Note that the operations to be performed by the event acquisition unit 102 after all event processing has completed are the same as in Embodiment 1 (FIG. 7).

In this way, according to Embodiment 2, the screen model held by the screen model construction unit 104 can be simplified by replacing some UI part groups of the screen model with integrated UI parts. This enables achieving the effect of speeding up traverse processing that is performed in order to generate drawing information from the screen model, in addition to the effect of Embodiment 1, even if the to-be-cached part group, includes any indeterminate part or any dynamically changing part.

### Embodiment 3

While the UI device according to Embodiment 1 performs the processing (FIG. 9) for generating drawing information from the to-be-cached part group excluding the exclusion part, Embodiment 3 describes a UI device that is capable of, along with the above processing, generating a mask relating to the overlap between exclusion parts and to-be-cached part groups that exclude the exclusion parts, and applying the generated mask at the time of combining the exclusion parts with the to-be-cached part groups. Specific examples of the mask include alpha blend masks, stencil masks, scissor masks, blur masks, and shadow masks. Alternatively, original masks may be generated in order to apply special effects.

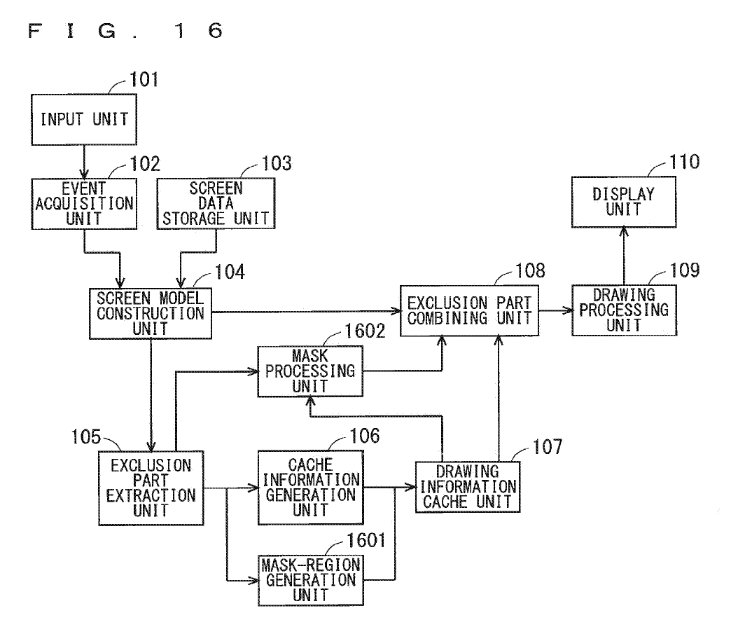

FIG. 16 is a block diagram of the UI device according to Embodiment 3. This UI device is configured by adding a mask-region generation unit 1601 and a mask processing unit 1602 to the configuration in FIG. 1.

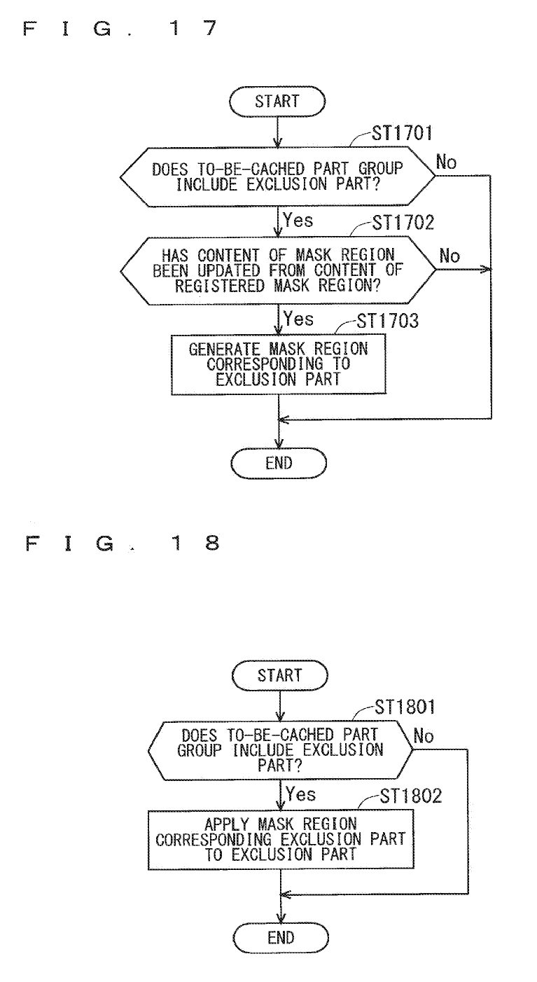

The mask-region generation unit 1601 performs processing for generating a mask region for an exclusion part. The procedure of this processing will be described with reference to the flowchart in FIG. 17. Assume that the content of the mask region generated for the exclusion part by the mask-region generation unit 1601 is to be registered (cached) in the drawing information cache unit 107, along with the drawing information about the to-be-cached part group after removal of exclusion parts.

First, the mask-region generation unit 1601 confirms whether the to-be-cached part group includes any exclusion part (step ST1701). If the to-be-cached part group includes no exclusion parts, the mask-region generation unit 1601 ends the processing without generating a mask region.

On the other hand, if the to-be-cached part group includes any exclusion part. the mask-region generation unit 1601 confirms whether the content of the mask region corresponding to this exclusion part has been updated (changed) from the content of the mask region already registered in the drawing information cache unit 107 (ST1702). If the mask region has not been updated, the mask-region generation unit 1601 ends the processing without generating a mask region. If the mask region has been updated, the mask-region generation unit 1601 generates a new mask region that corresponds to the exclusion part (step ST1703). Alternatively, two or more types of masks may be generated simultaneously for a single exclusion part.

The confirmation as to whether the content of the mask region has been updated in step ST1702 may be made by, for example, comparing the UI part parameter values between the exclusion part and the to-be-cached part group excluding the exclusion part. For example, it may be determined that the mask region has changed if the relative positions of the exclusion part and the to-be-cached part group excluding the exclusion part have been changed.

The mask processing unit 1602 performs processing for applying the mask region to the exclusion part. The procedure of this processing will be described hereinafter with reference to the flowchart in FIG. 18.

First, the mask processing unit 1602 confirms whether the to-be-cached part group includes any exclusion part (step ST1801). If the to-be-cached part group includes no exclusion parts, the mask processing unit 1602 ends the processing without applying the mask region to any exclusion part. On the other hand, if the to-be-cached part group includes any exclusion part, the mask processing unit 1602 applies the mask region to this exclusion part (step ST1802). Alternatively, two or more types of masks may be applied to a single exclusion part.

In Embodiment 3, a case where the screen model held by the screen model construction unit 104 has been updated by any event processing includes a case where the content of the mask region for the exclusion part has been updated and a case where the drawing information about the to-be-cached part group excluding the exclusion part has been updated. Although the processing for confirming whether the content of the mask region has been updated is performed by the mask-region generation unit 1601 (step ST1702 in FIG. 17), the processing for confirming whether the drawing information about the to-be-cached part group excluding the exclusion part has been updated is implemented by the cache information generation unit 106.

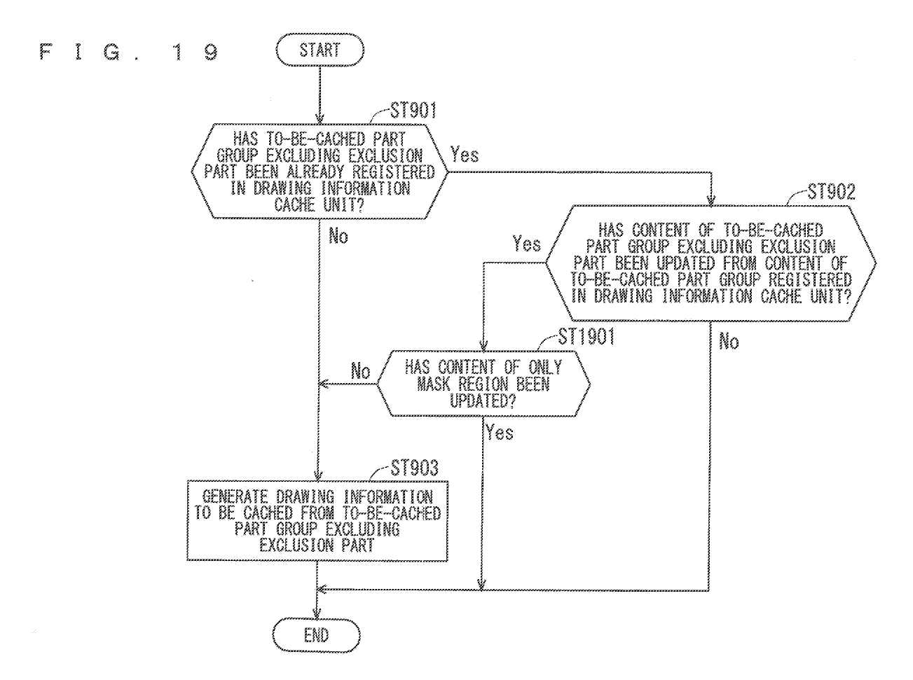

FIG. 19 is a flowchart of operations performed by the cache information generation unit 106 according to Embodiment 2. This flowchart is obtained by adding step ST1901 to the flowchart in FIG. 9.

Step ST1901 is performed when the content of the to-be-cached part group from which the exclusion part is excluded by the exclusion part extraction unit 105 has been updated (changed) from the content of the registered to-be-cached part group. In step ST1901, the cache information generation unit 106 confirms whether the updating of the content of the to-be-cached part group is the updating of only the content of the mask region. At this time, if only the content of the mask region has been updated, the cache information generation unit 106 ends the processing without executing step ST903. If any content other than the mask region has been updated, the cache information generation unit 106 executes step ST903. Note that the confirmation of updating in step ST1901 may be made by, for example, comparing the UI part parameter values between the exclusion part and the to-be-cached part group excluding the exclusion part, as in step ST1702 in FIG. 17.

In this way, according to Embodiment 3, when there is an overlap in display area between the exclusion part and the to-be-cached part group excluding the exclusion part, a mask can be applied to the area of overlap. Thus, even if there is an overlap between the exclusion part and the to-be-cached part group excluding the exclusion part, the effect of Embodiment 1 can be achieved while maintaining consistency in the content of the screen.

### Embodiment 4

While, in the UI device according to Embodiment 1, drawing information corresponding to the screen model held by the screen model construction unit 104 for a screen that is currently being displayed (hereinafter, referred to as a “current screen”) is cached in the drawing information cache unit 107, Embodiment 4 describes a UI device that is configured to anticipate a screen to be displayed next (hereinafter, referred to as a “next screen”), construct a screen model for the next screen in advance, and cache drawing information that corresponds to the screen model for the next screen in the drawing information cache unit 107.

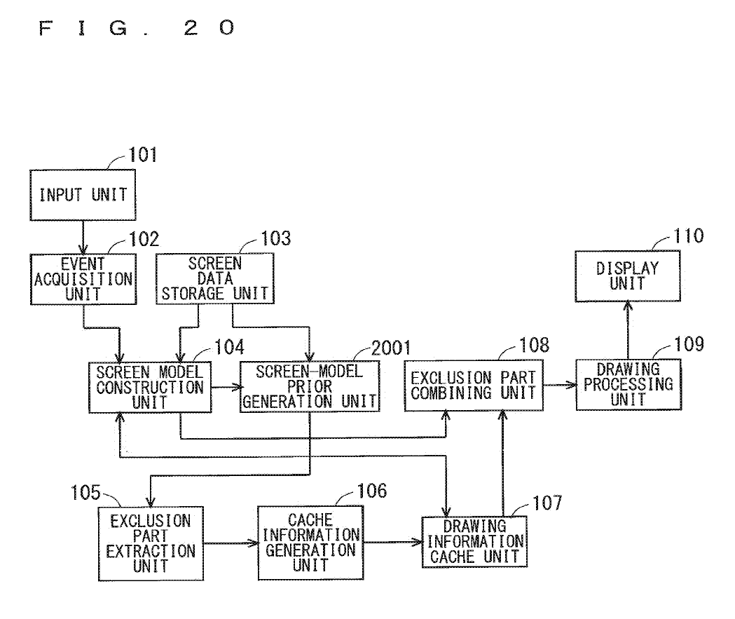

FIG. 20 is a block diagram of the UI device according to Embodiment 4. This UI device is configured by adding a screen-model prior generation unit 2001 to the configuration in FIG. 1. While FIG. 20 illustrates flows of data or requests (arrows in FIG. 20) that are necessary for the screen-model prior generation unit 2001 to construct a screen model for the next screen in advance and cache the screen model in the drawing information cache unit 107, other flows of data or requests (arrows in FIG. 1) that are not illustrated in FIG. 20 may also be included.

The screen-model prior generation unit 2001 performs processing for generating, in advance, a screen model for the next screen to which the current screen possibly transitions. The procedure of this processing will be described hereinafter with reference to the flowchart in FIG. 21.

First, the screen-model prior generation unit 2001 confirms whether it is possible to generate a screen model for the next screen in advance (step ST2101). For example, the prior generation of a screen model for the next screen needs to be performed after the screen model construction unit 104 has completed updating of the screen model, because the content of the next screen to which the current screen possibly transitions changes with the updating of the screen model by the screen model construction unit 104. Whether it is possible to generate a screen model in advance may be determined in consideration of factors such as processing load conditions during the screen update processing and processing load conditions of applications that are being executed by the UT device. When it is determined that the prior generation of a screen model is not possible, the screen-model prior generation unit 2001 immediately ends the processing.

When it is determined that the prior generation of a screen model is possible, the screen-model prior generation unit 2001 references the parameter values or screen transition chart of the screen model for the current screen held by the screen model construction unit 104, and confirms whether one or a plurality of next screens to which the current screen possibly transitions include any screen that can be generated in advance (can be anticipated) (step ST2102). Whether it is possible to anticipate the next screen may be determined depending on, for example, whether the result of an event processing program for causing screen transition is determined statically. If there is no next screen that can be generated in advance, the screen-model prior generation unit 2001 immediately ends the processing.

If there is any next screen that can be generated in advance, the screen-model prior generation unit 2001 determines which of the next screens to generate in advance (step ST2103). Which of the next screens to generate in advance may be determined on the basis of, for example, predetermined parameter values of the screen model for the current screen. Alternatively, a transition tendency may be analyzed using a history of occurrence of past events, and a next screen that meets a predetermined condition, such as a screen to which the current screen transitions frequently, may be determined as a next screen to be generated in advance.

When the screen to be generated in advance has been determined, the screen-model prior generation unit 2001 generates a copy of the screen model for the current screen held by the screen model construction unit 104 (step ST2104). The screen-model prior generation unit 2001 then performs screen transition processing on the copied screen model so as to generate a screen model for the next screen (ST2105). The screen transition processing performed on the screen model may be implemented by, for example, issuing a virtual event for causing the current screen to transition to the next screen generated in advance. At this time, the screen transition processing may be performed on only some UI parts of the screen model.

Note that the screen model for the next screen generated in advance is handled as a whole as a to-be-cached part group and transmitted to the exclusion part extraction unit 105. Subsequently, the screen model is cached in the drawing information cache unit 107 through the same steps as in Embodiment 1.

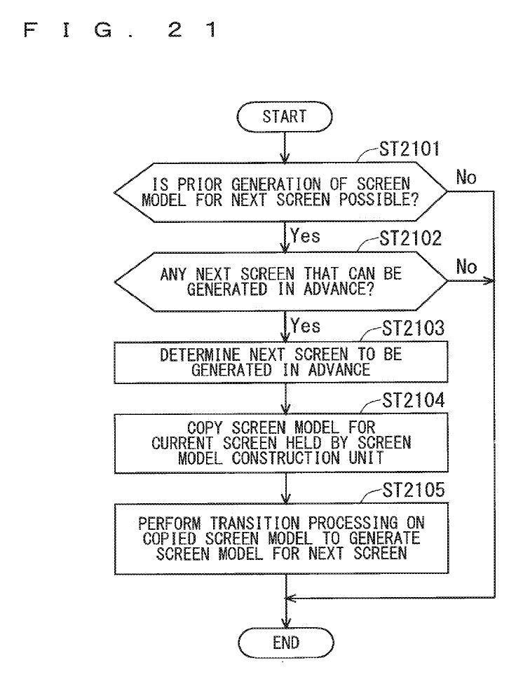

If the entire screen model for the next screen is cached in the drawing information cache unit 107 when an event that causes the screen to transition to the next screen has actually occurred, the screen model construction unit 104 may replace the screen model with the screen model for the next screen and may skip those steps that can be omitted from the remaining, event processing relating to transition to the next screen. The procedure of this processing will be described with reference to the flowchart in FIG. 22. The flowchart in FIG. 22 is obtained by adding processing in the following steps ST2201 to ST2205 between steps ST701 and ST702 in FIG. 7.

When an event that changes the content of the screen has occurred, the screen model construction unit 104 checks for the presence of any other event to be processed (step ST701). At this time, if any event remains to be processed, the screen model construction unit 104 confirms whether this event is a screen transition event relating to prior generation of the next screen (step ST2201). If this event is not a screen transition event relating to prior generation of the next screen, the procedure proceeds to step ST702 in which the screen model construction unit 104 performs processing for this event.

If the event is a screen transition event relating to prior generation of the next screen, the screen model construction unit 104 confirms whether a screen model for the next screen that is a transition destination is cached in the drawing information cache unit 107 (step ST2202). If the screen model is not cached, the screen model construction unit 104 executes step ST702 to perform processing for this event.

If the screen model for the transition destination is cached, the screen model construction unit 104 confirms whether the screen model held by the screen model construction unit 104 has been replaced with the already cached screen model (step ST2203). If the screen model has not been replaced, the screen model held by the screen model construction unit 104 is replaced with the screen model for the next screen cached in the drawing information cache unit 107 (step ST2204). If the screen model has already been replaced, step ST2204 is not carried out.

After step ST2203 or ST2204 has finished, the screen model construction unit 104 confirms whether the processing performed for this event is associated with an exclusion part (step ST2205). If the processing performed for this event is associated with an exclusion part, the procedure proceeds to step ST702 in order to update the content of the exclusion part and perform the processing for this event. If the processing performed for the event is not associated with any exclusion part, the procedure skips step ST702 and returns to step ST701.

With the UI device according to Embodiment 4, a screen model for the next screen can be constructed and cached, which includes a screen including a UI part such as an indeterminate part or a dynamically changing part whose content is determined only when actually displayed on the screen. Thus it is possible to achieve a UI device that is capable of high-speed screen transition.

### Embodiment 5

While, in the UI device according to Embodiment 1, the UI part parameter value indicating whether the UI part is an exclusion part is defined for each UI part in advance (e.g., at the stage of design of the screen) and is used to determine whether each UI part is an exclusion part, Embodiment 5 describes a UI device that determines which of UI devices is to be regarded as an exclusion part, on the basis of information other than the UI part parameter value indicating whether the UI part is an exclusion part, such as other UI part parameter values indicating other information, the content of the event that has occurred, and other dynamic information. In the present embodiment, information that is used to determine a UI device regarded as an exclusion part is referred to as “exclusion part determination information.”

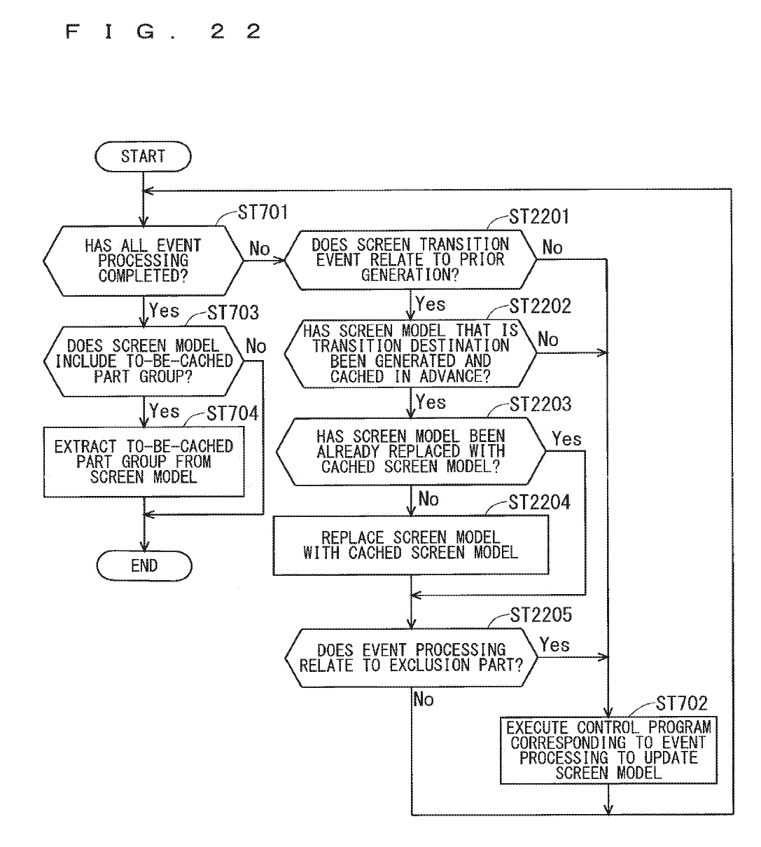

FIG. 23 is a block diagram of the UI device according to Embodiment 5. This UI device is configured by adding an exclusion part determination unit 2301 between the screen model construction unit 104 and the exclusion part extraction unit 105 in the configuration in FIG. 1.

The exclusion part determination unit 2301 performs processing for determining a UI part that is regarded as an exclusion part from among the UI parts included in the to-be-cached part group. The procedure of this processing will be described hereinafter with reference to the flowchart in FIG. 24. In the present embodiment, the UI part parameter value, for each UI value that indicates whether the UI part is an exclusion part is set to an initial value of “FALSE” (i.e., the UI part is not an exclusion part).

First, the exclusion part determination unit 2301 confirms whether all UI parts in the to-be-cached part group have been checked (step ST2401). If the check has completed for all UI parts, the exclusion pant determination unit 2301 immediately ends the processing.

If any UI part remains to be checked, the exclusion part determination unit 2301 acquires the exclusion part determination information about the UI part that is to be checked from the screen model construction unit 104 and determines whether the UI part is an exclusion part on the basis of the exclusion part determination information (step ST2402). While the exclusion part determination information varies depending on the method for determining exclusion parts, examples of the exclusion part determination information include UI part parameter values, the content of the event that has occurred, and dynamic information held by other UI devices. An exemplary determination method will be described later.

Thereafter, the exclusion part determination unit 2301 confirms whether the checked UI part is determined as an exclusion part (step ST2403). If the UI part is not determined as an exclusion part, the procedure returns to step ST2401 (i.e., the UI part parameter value indicating whether the UI part is an exclusion part remains “FALSE”). If the UI part is determined as an exclusion part, the exclusion part determination unit 2301 sets the UI part parameter value indicating whether the UI part is an exclusion part to “TRUE” (step ST2404), and the procedure returns to step ST2401.

Examples of the method for determining an exclusion part in step ST2402 include:

(a) a method in which the current screen model is compared with the past screen model, and a UI part whose position relative to the other UI parts has changed is determined as an exclusion part;

(b) a method in which a UI part for which an animation event that continuously updates the display content is set or enabled is determined as an exclusion part;

(c) a method in which a UI part for which an event such as a timer event or a gesture event that updates the display content of the UI part itself is set or enabled is determined as an exclusion part; and

(d) a method in which a UI part that includes hardware information or application information such as time, temperature, and radio-wave reception conditions in the display content is determined as an exclusion part.

With the UI device according to Embodiment 5, it is possible to dynamically change an exclusion part according to the content of the screen or the execution status of an application. In addition, there is no need to preset the UI part parameter value indicating whether the UI part is an exclusion part, which facilitates design of the screen and management of the UI parts.

### Embodiment 6

While, in the UI device according to Embodiment 1, the UI part parameter value indicating whether each UI part is to be cached is defined for each UI part in advance (e.g., at the stage of design of the screen) so as to enable extraction of to-be-cached part groups, Embodiment 6 may be such that a “drawing tendency” is calculated from information other than the UI part parameter value indicating whether the UI part is an exclusion part, such as other UI part parameter values indicating other information, the content of an event that has occurred, and other dynamic information, and this “drawing tendency” is used to as a basis to extract to-be-cached part groups and determine exclusion parts.

The “drawing tendency” as used herein is defined as structural characteristics of screen models or UI parts or numerical characteristics of UI part parameter values, which are based on the drawing information about screens and UI parts displayed in the past and statistical data about pre-provided drawing information. For example, there is a method for calculating, as a drawing tendency, a snap that records the number of times the structure of lower-level UI parts (child UI parts) has changed during past screen transition for each UI part, and a map that records the number of times the UI part parameter values have changed in the past for each UI part. As another example, a map that indicates a history of user usage, a map that indicates load conditions of each hardware device, a map that indicates the execution status of each application, or a combination of these maps may be calculated as a drawing tendency from a history of event processing.

As another alternative, the method for calculating a drawing tendency may use a statistical technique such as weighted averaging or machine learning, instead of simply counting the number of times the structure of UI parts has changed or the UI part parameter values have changed. In the case where a large number of hardware resources are required to calculate a drawing tendency, such as in the case of deep learning which is one technique for machine learning, calculation processing may be performed by a device other than the UI device, such as a cloud service, and the result of the processing may be acquired from the outside via a network and used as a drawing tendency.

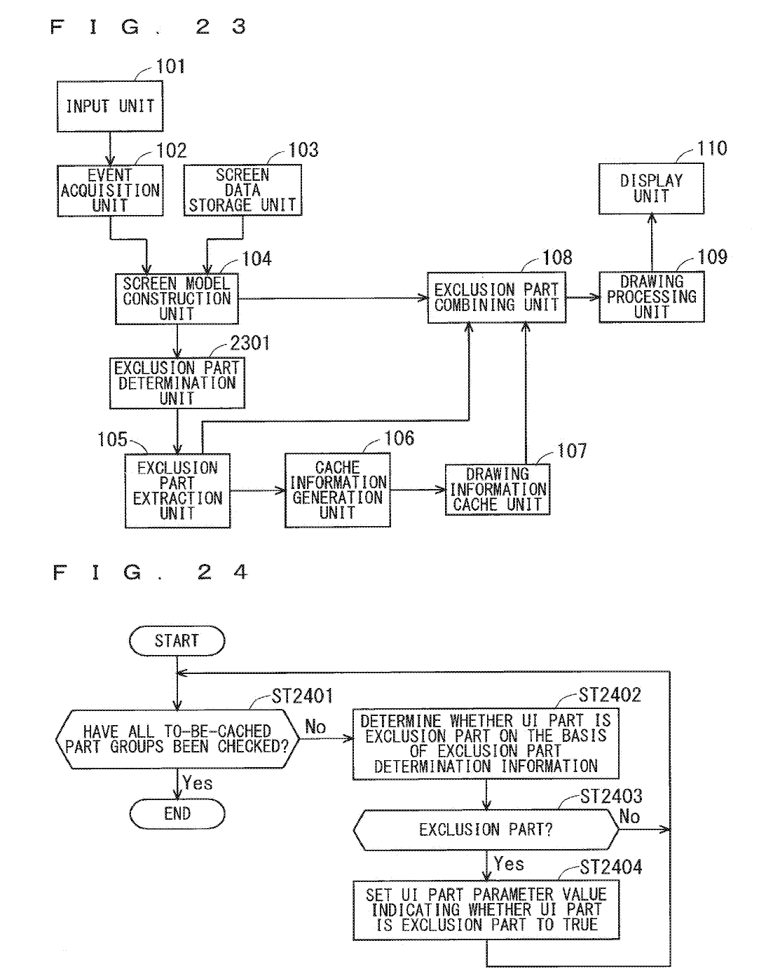

FIG. 25 is a block diagram of a UI device according to Embodiment 6. This UI device is configured by adding a drawing tendency estimation unit 2501, a drawing tendency holding unit 2502, and a to-be-cached-part determination unit 2503 to the configuration in FIG. 23.

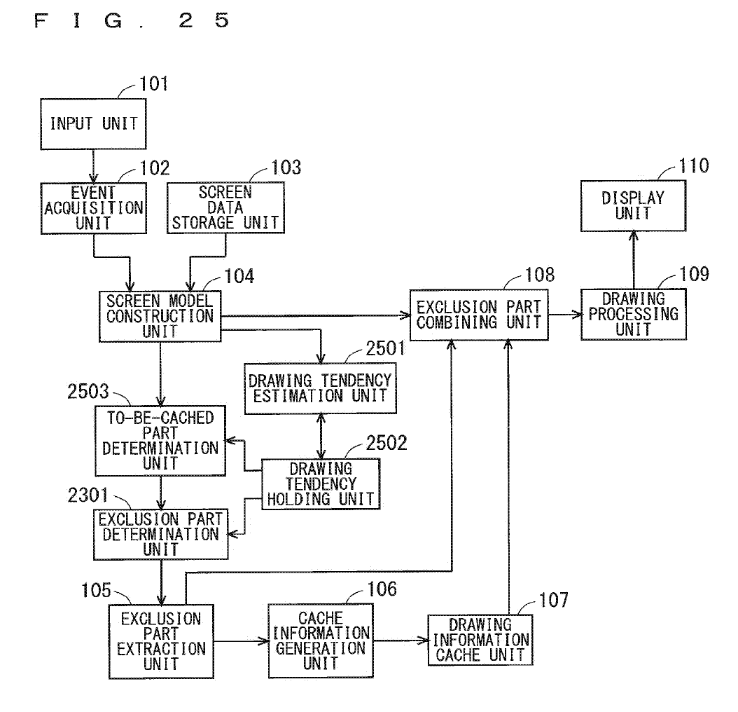

The drawing tendency estimation unit 2501 performs processing for estimating the current drawing tendency from the content of the screen model updated by the screen model construction unit 104 and the drawing tendency held by the drawing tendency holding unit 2502 and registering the estimated drawing tendency to the drawing tendency holding unit 2502. The procedure of this processing will be described hereinafter with reference to the flowchart in FIG. 26.

First the drawing tendency estimation unit 2501 acquires the current screen model from the screen model construction unit 104 (step ST2601) and acquires the drawing tendency of UI parts that constitute the screen model from the drawing tendency holding unit 2502 (step ST2602). The drawing tendency estimation unit 2501 then calculates a new drawing tendency from the acquired screen model and the acquired drawing tendency of the UI parts (step ST2603).

For example, when a map that records the number of times the structure of child UI parts has changed for each UI part, and a map that records the number of times the UI part parameter values have changed for each UI part are used as a drawing tendency, in step ST2503, the drawing tendency estimation unit 2501 performs processing for comparing the screen model used for the previous drawing and the current screen model to extract any UI part for which the structure of child UI parts has changed or the UI part parameter values have changed, and incrementing the number of times by one for that UI part. If the structure of child UI parts or the UI part parameter values have changed for a UI part that is not included in any map, the drawing tendency estimation unit 2501 performs processing for adding an element corresponding to this UI part to the map.

Thereafter, the drawing tendency estimation unit 2501 transmits the calculated. new drawing tendency to the drawing tendency holding unit 2502 (step ST2604).

The drawing tendency holding unit 2502 has a cache for holding the drawing tendency and performs processing for registering and holding the drawing tendency received from the drawing tendency estimation unit 2501. The procedure of this processing will be described hereinafter with reference to the flowchart in FIG. 27.

First, the drawing tendency holding unit 2502 confirms whether the drawing tendency received from the drawing tendency estimation unit 2501 have been registered for all UI parts (step ST2701). If the registration of the drawing tendency has completed for all UI parts, the drawing tendency holding nit 2502 immediately ends the processing. If any drawing tendency remains to be registered, the drawing tendency holding unit 2502 performs processing for registering the remaining drawing tendency, but at this time the drawing tendency holding unit 2502 confirms whether the drawing tendency for the same UI part as the UI part whose drawing tendency is to be registered has already been registered (step ST2702). If the drawing tendency for the same UI part has already been registered, the drawing tendency holding unit 2502 replaces the registered drawing tendency with a new drawing tendency (step ST2703). If the drawing tendency for the same UI part is not registered, the drawing tendency holding unit 2502 registers the drawing information for this UI part as a drawing tendency for a new UI part (step ST2704).

While FIG. 27 shows a case in which only the latest drawing tendency is registered in the drawing tendency holding unit 2502 for each UI part, not only the latest drawing tendency but also past drawing tendencies may be registered as auxiliary information, and the past drawing tendencies may also be used as necessary to calculate a drawing tendency.

The drawing tendency holding unit 2502 also performs processing for acquiring a registered drawing tendency in response to a request from the drawing tendency estimation unit 2501, the to-be-cached-part determination unit 2503, or the exclusion part determination unit 2301. At this time, if the drawing tendency for the UI part that is requested to be acquired is registered, the drawing tendency holding unit 2502 acquires this drawing tendency, but if the drawing tendency for the UI part that is requested to be acquired is not registered in the cache, the drawing tendency holding unit 2502 notifies the unit that made the request that the drawing tendency is not registered.

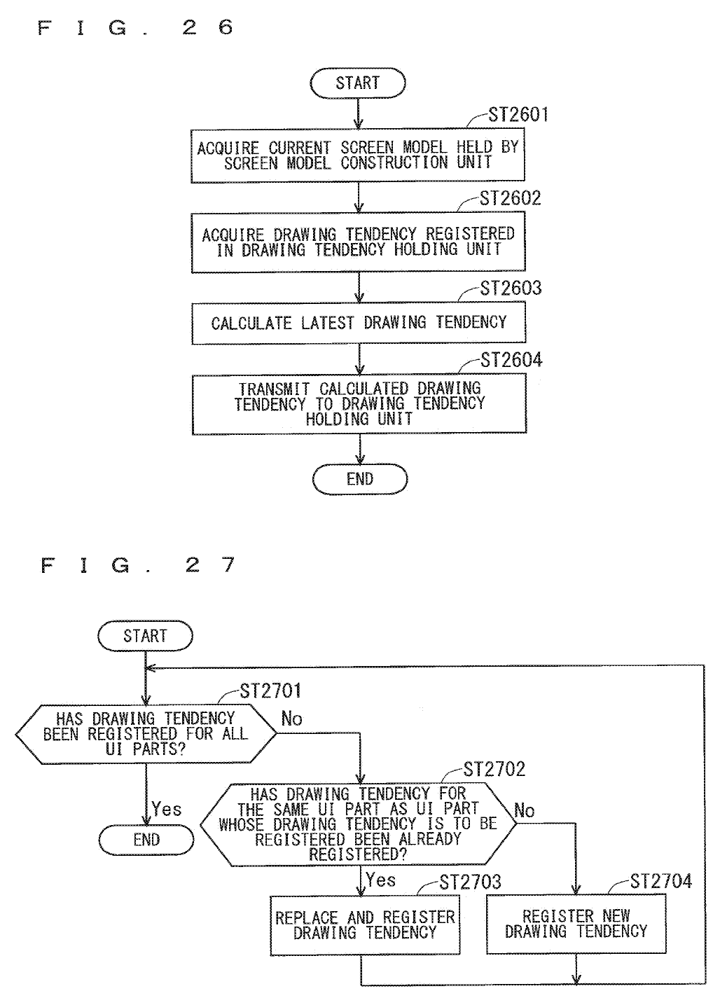

The to-be-cached-part determination unit 2503 performs processing for determining a to-be-cached part group from the drawing tendencies registered in the drawing tendency holding unit 2502, on the screen model held by the screen model construction unit 104. This processing will be described hereinafter with reference to the flowchart in FIG. 28.

First, the to-be-cached-part determination unit 2503 acquires the screen model from the screen model construction unit 104 and also acquires the drawing tendencies for all UI parts that constitute this screen model from the drawing tendency holding unit 2502 (step ST2801). Next, the to-be-cached-part determination unit 2503 determines a to-be-cached part group on the basis of the acquired screen model and the acquired drawing tendencies for the UI parts (step ST2802).

One example of the method for determining a to-be-cached part group is that a map that records the number of times the structure of child UI parts has changed for each UI part and a map that records the number of times the UI part parameter values have changed for each UI part are referenced, and a sub-graph that uses, as a root, a UI part for which the numbers of times of the changes is either zero or not registered and that belongs to a highest layer in the hierarchical structure among each UI part of the screen model is determined as a to-be-cached part group.

When the to-be-cached part group has been determined, the to-be-cached-part determination unit 2503 updates the UI part parameter value for each UI part included in the determined to-be-cached part group so as to indicate that the UI part is to be cached (step ST2803).

Here, the exclusion part determination unit 2301 according to Embodiment 6 determines an exclusion part from among the to-be-cached part group determined by the to-be-cached-part determination unit 2503. The operation of the exclusion part determination unit 2301 differs from the operation of the exclusion part, determination unit 2301 according to Embodiment 5 in that the exclusion part determination unit 2301 acquires a drawing tendency registered in the drawing tendency holding unit 2502 as necessary information to determine whether the UI part is an exclusion part in step ST2401 in FIG. 24, and in that the exclusion part determination unit 2301 determines an exclusion part on the basis of the drawing tendency in step ST2403.

One example of the method for determining an exclusion part is that a map that records the number of times the structure of child UI parts has changed for each UI part and a map that records the number of times the UI part parameter values have changed for each UI part are referenced, and in the to-be-cached part group, a UI part for which the number of times of the changes is greater than or equal to a predetermined threshold value is determined as an exclusion part.

With the UI device according to Embodiment 6, it is possible to dynamically change a to-be-cached part group and an exclusion part according to the content of a screen or the execution status of an application. In addition, there is no need to preset the UI part parameter value indicating whether the UI part is included in a to-be-cached part group, which facilitates design of the screen and management of the UI parts.

### Embodiment 7

While Embodiments 1 to 6 assume a situation where a single UI device performs all processing, one or more constituent elements among the cache information generation unit 106, the integrated-UI-part generation unit 1201, the mask-region generation unit 1601, the screen-model prior generation unit 2001, the exclusion part determination unit 2301, the drawing tendency estimation unit 2501, and the to-be-cached-part determination unit 2503 may be implemented by an external execution device (hereinafter, referred to as an “external device”) that is connected via a network. In particular, the processing relating to the to-be-cached part group excluding exclusion parts does not commonly handle information that changes dynamically or in real time, and therefore can be entrusted readily to an external device.

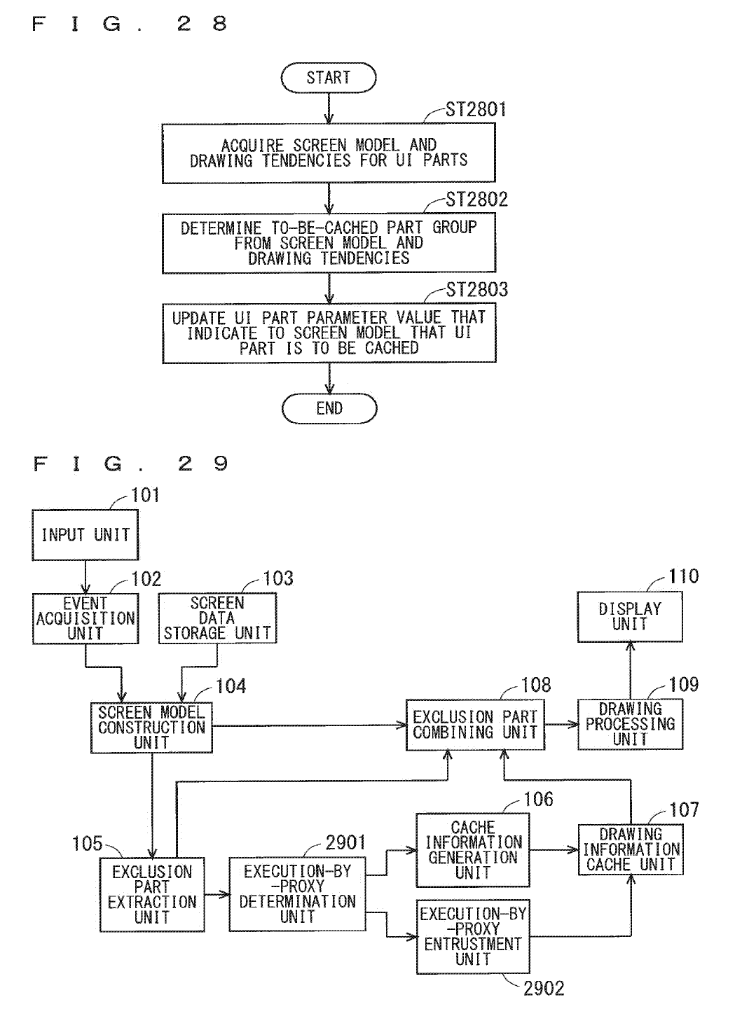

FIG. 29 is a block diagram of a UI device according to Embodiment 7. This UI device is configured by adding an execution-by-proxy determination unit 2901 and an execution-by-proxy entrustment unit 2902 to the configuration in FIG. 1. The UI device is configured to be capable of using an external device as a proxy to execute the processing performed by the cache information generation unit 106, i.e., the processing for generating drawing information (cache information) to be cached in the drawing information cache unit 107 from the to-be-cached part group.

The execution-by-proxy determination unit 2901 performs processing for determining whether the processing for generating cache information from the to-be-cached part group received from the exclusion part extraction unit 105 is, to be executed by the cache information generation unit 106 in the UI device or by an external device acting as a proxy. The procedure of this processing be described hereinafter with reference to the flowchart in FIG. 30.

First, the execution-by-proxy determination unit 2901 confirms whether it is possible to entrust the execution of the processing to an external device, which acts as a proxy (step ST3001). Examples of the case where it is not possible to entrust the execution to an external device acting as a proxy include a case where a network for communication with the external processing cannot be used, and a case where the external device is executing other processing.

If it is possible to entrust the execution to an external device acting as a proxy, the execution-by-proxy determination unit 2901 determines whether the content of the processing is the one whose execution needs to be entrusted to an external device acting as a proxy (step ST3002). This determination may be made on, the basis of information such as the calculation amount required in the processing to be entrusted, the need for real-time execution of the processing to be entrusted, and hardware load conditions of the UI device. The determination may also be made on the basis of past statistical information or learning data. In the UI device in FIG. 29, the calculation amount required in the processing to be entrusted to the external device corresponds to the calculation amount required in the processing for generating cache information from the to-be-cached part group. One example of the method for estimating the calculation amount is a method in which the total number of UI parts included in the to-be-cached part group, calculated by weighing data according to the type of each UI part (e.g., an image part or a text part), is regarded as the calculation amount.

If the content of the processing is the one whose execution needs to be entrusted to an external device, the execution-by-proxy determination unit 2901 determines to entrust the execution of this processing to an external device acting as a proxy (step ST3003). In this case, the execution-by-proxy determination unit 2901 notifies the execution-by-proxy entrustment unit 2902 that the processing is to be executed by proxy, and transmits necessary data for execution by proxy to the execution-by-proxy entrustment unit 2902. In the UI device in FIG. 29, the to-be-cached part group is transmitted from the execution-by-proxy determination unit 2901 to the execution-by-proxy entrustment unit 2902.

On the other hand, if it is possible to entrust the execution of the processing to an external terminal acting as a proxy and if the content of the processing is not the one whose execution needs to be entrusted to an external terminal, the execution-by-proxy determination unit 2901 determines to execute this processing within the UI device (step 3004). In this case, the cache information generation unit 106 generates cache information as in Embodiment 1.

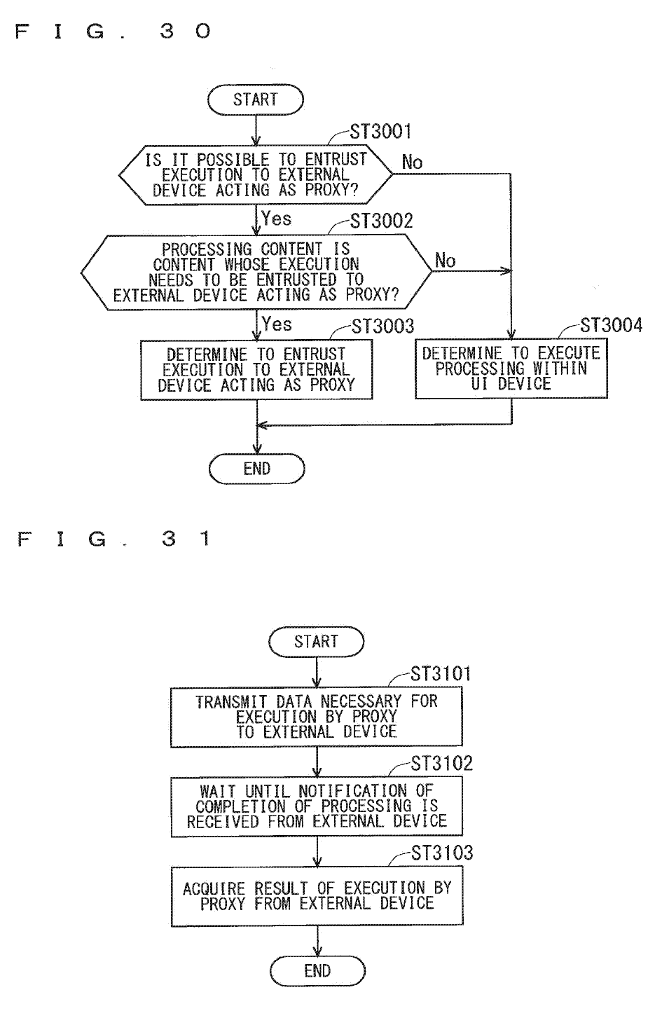

When the execution-by-proxy determination unit 2901 has determined to entrust the processing to an external device, the execution-by-proxy entrustment unit 2902 performs processing for entrusting the processing for generating cache information to an external device, and acquiring, cache information generated by the external device. The procedure of this processing will be described hereinafter with reference to the flowchart in FIG. 31.

First, the execution-by-proxy entrustment unit 2902 transmits, via a network, data that is necessary to entrust execution to the external device acting as a proxy (step ST3101). In the UI device in FIG. 29, the data to be transmitted to the external device is the to-be-cached part group. Thereafter, the execution-by-proxy entrustment unit 2902 waits until a notification of completion of the processing is received from the external device (step ST3102). When the notification of completion of the processing has been received from the external device, the execution-by-proxy entrustment unit 2902 acquires the result of the processing from the external device (step ST3103). In the UI device in FIG. 29, the execution-by-proxy entrustment unit 2902 acquires cache information as a result of the processing from the external device.

In step ST3102, the execution-by-proxy entrustment unit 2902 may employ method for making an inquiry about whether the processing has completed at regular intervals, instead of waiting for the receipt of the notification of completion of the processing. Alternatively, steps ST3102 and ST3103 may be regarded as a single step, and the result of the processing transmitted from the external device may be regarded as a notification of completion of the processing.

While FIG. 29 illustrates the UI device that is configured to entrust the processing that is to be performed by the cache information generation unit 106 to an external device, one or more processes that are supposed to be performed by the cache information generation unit 106, the integrated-UI-part generation unit 1201, the mask-region generation unit 1601, the screen-model prior generation unit 2001, the exclusion part determination unit 2301, the drawing tendency estimation unit 2501, and the to-be-cached-part determination unit 2503 illustrated in Embodiments 1 to 6 may be entrusted to an external device. In this case as well, the execution-by-proxy determination unit 2901 may be disposed before an element (functional block) whose processing is to be entrusted to an external terminal, and the execution-by-proxy entrustment unit 2902 may be disposed in parallel with that element. Moreover, in order to reduce the amount of data flowing over a communication channel that connects the UI device and the external device, a copy of data necessary for the entrustment processing, such as screen data stored in the screen data storage unit 103, may be stored in the external device.

With the UI device according to Embodiment 7, it is possible to distribute processing loads on the UI device by using an external device to execute part of the drawing processing. This improves drawing performance.

### Embodiment 8

The processing for constructing a screen model according to Embodiment 1 is an example of the case where the processing for determining UI part parameter values is assumed to be executed in an arbitrary order for each UI part that constitutes the screen model, irrespective of whether the UI part is an exclusion part. However, if there is a UI part that determines its own UI part parameter values on the basis of UI part parameter values for exclusion parts, the UI part parameter values for the exclusion parts need to be first determined because the UI part parameter values for the UI part will change with a change in the UI part parameter values for the exclusion parts. In this case, for example, UI parts that are in a dependency relation with exclusion parts may also be regarded and handled as exclusion parts. Here, a case where two UI parts (first UI part and second UI part) are in a dependency relation is defined as a case where the first UI part references data of the second UI part, or a case where the action of the second UI part, such as a function call, affects the first UI part.

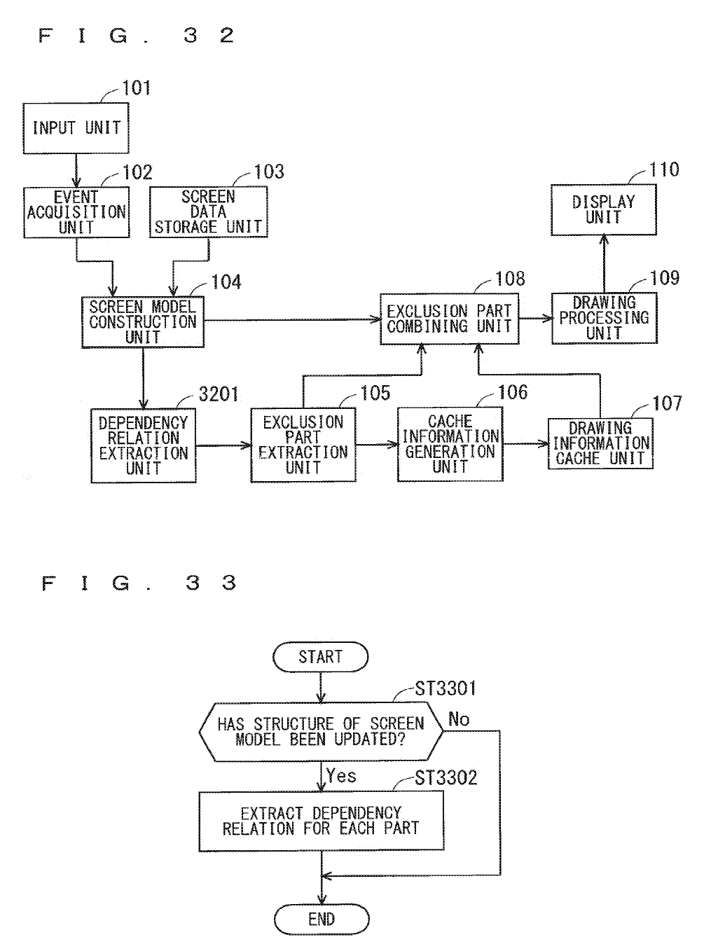

FIG. 32 is a block diagram of the UI device according to Embodiment 8. This UI device is configured by adding a dependency relation extraction unit 3201 to the configuration in FIG. 1. The dependency relation extraction unit 3201 performs processing for extracting dependency relations from the screen model held by the screen model construction unit 104. The procedure of this processing will be described hereinafter with reference to the flowchart in FIG. 33.

First, the dependency relation extraction unit 3201 confirms whether the structure of the screen model held by the screen model construction unit 104 has been updated (step ST3301). If the structure of the screen model has not been updated, the dependency relation extraction unit 3201 ends the processing without executing step ST3302.

If the structure of the screen model has been updated, the dependency relation extraction unit 3201 extracts a dependency relation for each unit from the screen model (step ST3302). One example of the method for extracting a dependency relation is a method for creating a dependency graph through processes such as dynamic program analysis or user input prediction. Alternatively, in order to facilitate the extraction of a dependency relation, constraints may be added so that only a dependency relation between UI parts that are in a parent-child relation (relation between upper and lower levels) is taken into consideration in the hierarchical, structure of the screen model.

The exclusion part extraction unit 105 for excluding exclusion parts from UI parts in FIG. 32 excludes, in addition to exclusion parts extracted by the same method as in Embodiment 1 (UI parts whose UI part parameter values indicate that the UI parts are exclusion parts), UI parts that are dependent on those exclusion parts as exclusion parts. This processing is performed on the basis of the dependency relation among the UI parts extracted by the dependency relation extraction unit 3201.

With the UI device according to Embodiment 8, since UI parts that are dependent on exclusion parts are also designated as exclusion parts, it is possible to separate exclusion parts from the other UI parts in the to-be-cached part group without causing any inconsistency in the content of drawing.

Note that embodiments of the present invention may be freely combined or appropriately modified or omitted within the scope of the present invention.

While the invention has been shown and described in detail, the foregoing description is in all aspects illustrative and not restrictive. It is therefore to be understood that numerous modifications and variations can be devised without departing from the scope of the invention.

### REFERENCE SIGNS LIST

101: Input unit, 102: Event acquisition unit, 103: Screen data storage unit, 104: Screen model construction unit, 105: Exclusion part extraction unit, 106: Cache information generation unit, 107: Drawing information cache unit, 108: Exclusion part combining unit, 109: Drawing processing unit, 110: Display unit, 210: Input device, 220: Computer, 221: Processor, 222: Storage, 230: Display, 1201: Integrated-UI-part generation unit, 1601: Mask-region generation unit, 1602: Mask processing unit, 2001: Screen-model prior generation unit, 2301: Exclusion part determination unit, 2501: Drawing tendency estimation unit, 2502: Drawing tendency holding unit, 2503: To-be-cached-part determination unit, 2901: Execution-by-proxy determination unit, 2902: Execution-by-proxy entrustment unit, 3201: Dependency relation extraction unit.

1-10. (canceled)

11. A user interface device comprising:
a processor to execute a program; and
a memory to store said program which, when executed by said processor, performs processes of:
excluding an indeterminate part or a dynamically changing part as an exclusion part on the basis of a content of a generated event from a to-be-cached part group among a plurality of UI parts that constitute a screen of a user interface (UI);
generating drawing information about said to-be-cached part group excluding said exclusion part;
registering drawing information about said to-be-cached part group excluding said exclusion part; and
in a case that a screen is drawn using the registered drawing information about said to-be-cached part group excluding said exclusion part, combining drawing information that corresponds to said exclusion part with the drawing information about said to-be-cached part group excluding said exclusion part.

12. The user interface device according to claim 11, wherein said processor further generates an integrated UI part that corresponds to the drawing information about said to-be-cached part group excluding said exclusion part, and registers drawing information about said integrated UI part.

13. The user interface device according to claim 11, wherein said processor further performs processes of:
generating a mask region that corresponds to an area of overlap between said exclusion part and a group of UI parts excluding said exclusion part, and registering said mask region; and
in a case that a screen is drawn using the registered drawing information about said to-be-cached part group excluding said exclusion part, applying said registered mask region to drawing information that corresponds to said exclusion part.

14. The user interface device according to claim 11, wherein said processor further generates drawing information about a screen to which a current screen possibly transitions, in advance and registers the generated drawing information.

15. The user interface device according to claim 11, wherein said processor further determines said exclusion part on the basis of a parameter value held by said to-be-cached part group.

16. The user interface device according to claim 11, wherein said processor further performs processes of:
estimating a drawing tendency that is either a structural characteristic of a screen model or a UI part, or a numerical characteristic of a UI part parameter value and registering said drawing tendency;
determining said to-be-cached part group on the basis of said drawing tendency; and
determining said exclusion part on the basis of said drawing tendency.

17. The user interface device according to claim 11, wherein said processor further performs processes of:
determining whether to entrust execution of part of processing to an external device acting as a proxy; and
in a case that it is determined to entrust the execution to an external device acting as a proxy, entrusting the execution to the external device acting as a proxy.

18. The user interface device according to claim 11, wherein said processor further extracts a dependency relation between said exclusion part and said to-be-cached part group excluding said exclusion part,
wherein a UI part that is dependent on said exclusion part in said to-be-cached part group is determined as said exclusion part.

19. A method for displaying a screen on a user interface device, comprising:
excluding an indeterminate part or a dynamically changing part as an exclusion part on the basis of a content of a generated event from a to-be-cached part group among a plurality of UI parts that constitute a screen;
generating drawing information about said to-be-cached part group excluding said exclusion part;
registering drawing information about said to-be-cached part group excluding said exclusion part; and
in a case that a screen is drawn using the registered drawing information about said to-be-cached part group excluding said exclusion part, combining drawing information that corresponds to said exclusion part with the drawing information about said to-be-cached part group excluding said exclusion part.
